(19) United States
(12) Patent Application Publication
(10) Pub. No.: US 2026/0052389 A1
(43) Pub. Date: Feb. 19, 2026

(54) TECHNIQUE FOR DETECTING A BOGUS RADIO BASE STATION

(71) Applicant: Telefonaktiebolaget LM Ericsson (publ), Stockholm (SE)

(72) Inventors: Athanasios KARAPANTELAKIS, Solna (SE); Konstantinos VANDIKAS, Solna (SE); Alexandros NIKOU, Danderyd (SE); Gabriella NORDQUIST, Stockholm (SE)

(21) Appl. No.: 19/100,990

(22) PCT Filed: Feb. 14, 2023
(86) PCT No.: PCT/EP2023/053618

§ 371 Date: Feb. 4, 2025

(30) Foreign Application Priority Data
Aug. 8, 2022 (GR) 20220100659

(51) Int. Cl. H04W 12/122; H04B 17/309; H04B 17/318; H04L 41/16; H04W 24/10

(52) U.S. Cl. CPC H04W 12/122; H04B 17/328; H04B 17/346; H04L 41/16; H04W 24/10

(57) ABSTRACT

A technique for detecting a fake radio base station, RBS, in a radio access network, RAN, comprising a plurality of RBSs is described. As to a method aspect, a neural network in an FRD module is trained according to reinforcement learning with a set of experiences. Each of the experiences relates to one of the RBSs and includes a state based on at least one observation of at least one radio device relative to the respective one of the RBSs, an action indicative of a degree of trust whether the respective one of the RBSs is a fake RBS, an updated state for the respective one of the RBSs, and a reward based on a likelihood function. The reward is indicative of a correlation between the action and the likelihood function for the respective one of the RBSs being a fake RBS based on the respective one of the states.

### TECHNICAL FIELD

The present disclosure relates to a technique for detecting a bogus or fake radio base station. More specifically, and without limitation, methods and devices are provided for detecting a fake radio base station in radio access network.

### BACKGROUND

The Third Generation Partnership Project (3GPP) defines different radio access technologies (RATs) such as fourth generation (4G) Long Term Evolution (LTE) and fifth generation (5G) New Radio (NR) for radio communication between radio devices, also referred to as user equipment (UE), via radio base stations (RBSs), also referred to as network nodes, of a radio access network (RAN). A mobile network may comprise the RAN and at least one core network (CN) serving the RAN. For example, multiple mobile network operators (MNOs) may operate subsets of the RBSs each served by a respective CN.

However, the RAN might comprise some fake (also referred to as false, bogus or rogue) RBSs such as International Mobile Subscriber Identity (IMSI) catchers, that are malicious devices that intercept wireless traffic and identity of UEs. The IMSI catchers may launch man-in-the-middle (MTM) attacks and may collect IMSIs of UEs, or may even eavesdrop on data traffic. In a longer-term effect, the UE may stay connected to these fake RBSs, thus not being able to make calls and/or receive messages via the short message service (SMS) and/or initiate data sessions and connect to the Internet.

3GPP as standardization body for mobile networks is trying to secure the mobile network from IMSI catchers in many ways including the use of temporary identifiers. For example, in 4G LTE and in 5G NR, the globally unique temporary identifier (GUTI) was standardized and used. Contrary to the IMSI, the GUTI is not permanent and is generated by the mobile network upon attach of a radio device. Therefore, the identity of the radio device is not revealed. It is also possible that the GUTI is changed while the radio device is connected to the mobile network, e.g., periodically during tracking area update (TAU) process.

In both 4G LTE and 5G NR, the GUTI contains three constituents:
a public land mobile network ID (PLMN ID) parameterized by the Mobile Country Code (MCC) and Mobile Network Code (MNC);
a mobility function identifier (e.g., the Core Access and Mobility Management Function (AMF) ID in 5G, and the Mobility Management Entity (MME) in 4G; and
a temporary IMSI (T-IMSI) (e.g., auto-generated).

The GUTI prevents a fake RBS from detecting the true identity of the UE, but the GUTI does not enable detecting a fake RBS or preventing a UE from connecting to the fake RBS. Hence, a fake RBS detector is desirable in order to trigger a response on behalf of the MNO or local authorities to send to the UE a message that warns of the existence of a potential threat.

There are several proposals in the state of art, for detecting presence of a fake RBS in RAN. The proposals fall into two main categories:
Radio device-based (e.g., UE-based):
For example the UE performs analysis of a collected data (e.g., in the form of a mobile application). In another example, crowd-sourced detectors augment observations from multiple UE to identify fake base stations.
Network-based (e.g., network node based):
For example, the network performs analysis of collected data, e.g., while actively communicating with the UE to identify fake RBSs. The network-based proposals include:
   a. Automatic neighbor relations (ANR)-based:
      The network uses cell relations to identify rogue cells. For example, US patent application US 2016/309 332 discloses a technique that relies on a neighbor relations table (NRT) to identify new cells that are potentially fake by comparing the measurements between reference cells (e.g., cell of a real RBS) and new cells that could be a cell of a potentially fake RBS.
   b. Nguyen et al., “Detecting IMSI-catcher using soft computing”, International Conference on Soft Computing in Data Science, Springer, Singapore, 2015, uses a machine learning model to detect anomalies in UE behavior that may indicate an issue with the RBS they are connecting to. The authors showcase a simple experiment of RAT change from 2G to 3G, wherein a high rate of change may indicate a fake RBS presence. Other data that can be used by the machine learning model may include temporary disappearance of a UE, which may indicate connection to a fake RBS, disabling of encryption, and “camping” of a UE on 2G instead of 3G.
   c. Steig et al., “A network based IMSI catcher detection”, 2016 6th International Conference on IT Convergence and Security (ICITCS), IEEE, 2016, uses measurement report data sent from UE to measure signal strength of all cells (e.g., related to a real RBS or a fake RBS) within range of the UE. The measurement report consists of an identity of each of the base stations in range of the UE and signal strength of each of these base station of a reference signal as received by the UE. The algorithm for detection of fake RBS in first step, compares the identity of the base station with pre-existing identities to identify whether the identity is part of the network or not. In second step, the algorithm calculates the distance between serving base station and reported neighbors and compares them to distances found in the database. In case of a fake RBS being present, the algorithm will show a discrepancy between the distance of the fake RBS and the real RBS found from the database.

However, the UE-based techniques require specific modification to UE functionality, i.e., using a mobile application, therefore they are not suited for all UEs. For example, a mobile device that is not a smartphone (e.g., an IoT sensor) or an older phone or device for machine-type communication (MTC, e.g., an embedded device or a car radio) would not be able to run the software required to detect the fake RBS, or access and/or contribute to the crowdsourced database.

The network-based techniques consider detections by a single mobile network. However, there may exist multiple operators in an area that may be interested in the presence of a fake RBS, as UE from all operators may be affected by its presence and may want to take a collective action. Furthermore, the conventional network-based detection of a fake RBS may fail because the fake RBS is misinterpreted as being the RBS of another MNO.

Moreover, some network-based techniques may use machine-learning based approaches in the literature e.g., supervised learning, which requires the pre-existence of a “ground truth”, i.e., a dataset which can be used to train a model to predict whether a UE report is indicative of a fake or a real RBS. This approach however requires manual labelling and does not adapt to new types of threats, which may have different combinations of input features than the ones that the model was originally trained with.

The document US 2018/070 239 A1 discloses an abstract concept, wherein essentially a UE detects the presence of a fake RBS by producing a set of measurements and comparing their result with a baseline. According to this document, the knowledge of the cells comes from other operators of the RAN. Such information may be used to measure potential interference between existing cells and fake ones. For example, fake cells of the fake RBSs, due to their ad-hoc nature and unplanned existence, may interfere with existing real cells. Interference measurements are collected in operation administration and management (OAM).

The document WO 2022/003490 proposes a machine learning-based approach to detect fake cells using data from different UEs such as measurement reports. However, this proposal requires curating a dataset that contains the ground truth and stating which cells are true and which ones are fake plus, which is particularly challenging when dealing with highly imbalanced datasets, since the conventional training data is very likely to contain more real cells than fake ones, thus affecting the accuracy of the model.

### SUMMARY

Accordingly, there is a need for a technique that detects a fake RBS more effectively and more flexible. An alternative or more specific object is to improve a network-based technique for detecting a fake RBS for more than one operator.

As to a first method aspect, a method performed by a core node of an operator is provided. The core node comprising a fake radio base station detector (FRD) module for detecting a fake radio base station (RBS) in a radio access network (RAN) comprising a plurality of RBSs. The method comprises or initiates a step of training a neural network in the FRD module according to reinforcement learning with a set of experiences. Each of the experiences relates to one of the RBSs and comprises a state based on at least one observation of at least one radio device (RD) relative to the respective one of the RBSs, an action indicative of a degree of trust whether the respective one of the RBSs is a fake RBS, an updated state for the respective one of the RBSs, and a reward based on a likelihood function. The reward is indicative of a correlation between the action and the likelihood function for the respective one of the RBSs being a fake RBS based on the respective one of the states. The likelihood function is determined by the core node based on the at least one observation of the at least one radio device relative to the respective one of the RBSs. The method further comprises or initiates the step of operating the neural network for detecting a fake RBS.

The RAN may comprise, or may be associated with, one or more operators (e.g., network operator), each comprising a core node. Herein, the expression “network operator” may refer to a technical infrastructure (e.g., a subset of the RBSs and a core node) for providing radio access to the at least one radio device. Disjoint subsets of the plurality of RBSs may be associated to network operators, respectively. The network operators (which term may be used synonymous with the infrastructure) may be technically independent in that each one is capable of provide radio access. Furthermore, the network operators may be technically coupled in that a handover between RBSs of different network operators or roaming of the at least one radio device may be supported.

The core node may be in (e.g., radio or wired) communication with one or more of the RBSs (e.g., network nodes) of the RAN. The at least one RD may be in radio communication with one or more of the RBSs (e.g., a serving RBS) of one or more operators.

The RD (e.g., a user equipment, UE) may measure reference signal quality using metrics such as reference signal received power (RSRP) and a reference signal received quality (RSRQ) relative to one or more of the RBSs (e.g., network nodes). The RD may measure the reference signal quality (e.g., RSRP and/or RSRQ) for one or more RBSs including at least one serving RBS of the RD and/or at least one neighboring RBS of the serving RBS of the RAN. Alternatively or in addition, the RD may transmit a report indicative of the measured reference signal quality to the serving RBS (e.g., a list of <cell-ID, RSRP, RSRQ>).

Alternatively or in addition, the RD may report the at least one observation, e.g. to its serving RBS. In other words, the core node may receive an observation report indicative of the at least one observation from the at least one RD. The observation report may also be referred to as the reported observation, or briefly, the report. The observations received from the at least one radio device may also be referred to as radio device observations (e.g., as opposed to the observation augmented by the network information).

The report may be indicative of the connectivity of the respective RD relative to one or more of the RBSs, e.g., the report may comprise or indicate at least one of: one or more time stamps of camping to one or more of the RBSs of the RAN, one or more time stamps of detaching from one or more of the RBSs of the RAN, the measured RSRP of one or more of the RBSs of the RAN, the measured RSRQ of one or more of the RBSs of the RAN, and a Cell-ID of one or more of the RBSs of the RAN.

Alternatively or in addition, the report from the at least one RD may be indicative of a status of the RD relative to (i.e., in relation to) the respective one of the RBSs of the RAN.

Herein, a plurality of observations relative to one of the RBSs of the RAN may be referred to as a state (e.g., a state description) of the respective one of the RBSs of the RAN. The observations may be associated to the respective one of the RBSs of the RAN according to at least one of the cell-ID of the respective one of the RBSs of the RAN, and/or a latitude and longitude (which may be static) of the respective one of the RBSs of the RAN. For example, the state may comprise the measured RSRP and/or the measured RSRQ averaged and/or aggregated over one or more timespans for the respective one of the RBSs.

The plurality of the experiences (e.g., relative to a core node, optionally including experiences received from another core node of another operator) may be referred to as training data. The experiments may be understood as a Markov decision process (e.g., a four tuple form).

Alternatively or in addition, the training data may be unlabeled and/or anonymized data, e.g., by not including operator-specific or RD-specific data or identifiers.

The neural network (NN) may also be referred to as artificial neural network (ANN) or simulated neural network (SNN). The neural network may comprise layers of nodes. The layers may comprise an input layer, one or more hidden layers, and an output layer. Each node, e.g., an artificial neuron, may be connected to or may connect to one or more other nodes (e.g., in a neighboring layer). Alternatively or in addition, each node may comprise for each connection a neural network weight (or briefly, weight) associated with the respective connection. If the output of any individual node is above the threshold, the node is activated, i.e., the node sends a signal to the next layer of the network. Otherwise, no signal may pass along to the next layer of the neural network. Within each node may be a set of inputs, the weights associated with each of the inputs. As an input enters the node, it is multiplied by the associated weights and summed up to provide a value which may be used to provide the final output from the node (e.g., the value may be an input for an activation function which results the output of the node). Alternatively or in addition, the node may include an additional term to the summed up value called a bias. The bias may be understood as a negative threshold associated to the node.

The weights and/or the bias may be learnable (e.g., trainable), i.e. may be changed in the step of training according to the reinforcement learning based on the training data. The neural network may randomize (e.g., may choose random values for) the weight and/or the bias values before the training step begins. As the training step starts, the weight and/or the bias associated with each node may be adjusted toward the desired values (e.g., predefined values) and the correct output. For example, the weight and/or the bias associated with each node may be changed responsive to each input of an experience in the set of experiences.

The likelihood (L) may be the probability for the respective RBS being a fake RBS or not. The likelihood may be any number between 0 and 1. The likelihood may be computed based on a mathematical function of at least one observation of a RD relative to an RBS. The observation may comprise more than one parameters (e.g., RSRP, RSRQ, and etc.). The observation parameter may be for example radio access technology (RAT) of the RBS, timespan spent camped at the coverage network cell of the RBS, timespan detached from the RBS and etc. The mathematical function may comprise a coefficient corresponding to each observation parameters. The coefficients may be predefined coefficients and/or choose based on the experimental validations and/or dynamic coefficients.

The likelihood may be used by the FRD module as basis for training the neural network according to the reinforcement learning. The neural network may adjust (e.g., update) its weights and/or biases (e.g., of each node) through the training step. Alternatively or in addition, the neural network may repeat the training step (e.g., retrain). For example, the neural network after training step, (e.g., a trained neural network) may use new training data (e.g., a new set of experiences) to adjust (e.g., update) the weights and/or biases of its own nodes. As to another example, the trained neural network may use the weights and/or biases of another trained neural network, to update the weights and/or biases of its own nodes. As another example, the neural network may keep the previously trained layers and add some new layers on top of the existing trained layers to be trained (e.g., with new set of experience).

The neural network may receive a state comprising of at least one observation according to an RBS. The neural network may take an action (A) i.e., predict if the respective RBS is a fake RBS or not, based on the received state. The action may have a numerical representation. The numerical representation may be binary action space for trusted and not trusted (e.g., −1 corresponds to a real RBS and 1 corresponds to a fake RBS) and/or varying degrees of trust (e.g., a scale ranging from 1 to 5).

The neural network may be rewarded and/or punished (e.g., negatively rewarded) based on the taken action (A) and the likelihood (L). The reward may be indicative of “how effective the taken action (A) was” in comparison with the likelihood (L). The reward (R) may have an upper and lower bound. For example if the likelihood for an RBS being a fake RBS is L=0.7 and the taken action is A=1 (e.g., in binary action space, A=1 corresponds to a fake RBS), the reward would be R=0.7, and if the taken action for the same likelihood is A=−1 (e.g., in binary action space, A=−1 corresponds to a real RBS), the reward (e.g., punishment) would be R=−0.3. The reward may indicate how effective the action was.

The updated state may be based on at least one updated observation of the at least one radio device relative to the respective one of the RBSs. For example, the updated state may be independent of the action (e.g., of the corresponding experience also including the updated state), optionally even if the action results from a forward pass of the neural network.

The step of operating the neural network for detecting a fake RBS may comprise labeling a data set (e.g., the states, or the updated states, of the RBSs). A classification model may be trained on the labeled data set (e.g., the data set resulting from the step of operating the neural network). The trained classification model may (e.g., in an implementation of the operating step) be applied to a further data set (e.g., the updated states or further states of the RBSs or further RBSs) to determine if the respective RBSs are fake or not.

The at least one observation of the at least one radio device (e.g., according to the method aspect) may comprise at least one of a channel quality of a radio channel between the at least one radio device and the respective one of the RBSs; a signal to noise ratio (SINR) measured at the at least one radio device; a received signal strength indicator (RSSI) measured at the at least one radio device; reference signal received power (RSRP) measured at the at least one radio device; reference signal received quality (RSRQ) measured at the at least one radio device; at least one international mobile subscriber identity (IMSI) of the at least one radio device; a cell-ID of a cell of the respective one of the RBSs; a latitude of the respective of one of the at least one radio device or a latitude of a cell of the respective one of the RBSs; a longitude of the respective of one of the at least one radio device or a longitude of a cell of the respective one of the RBSs; a radio access technology (RAT) of the respective one of the RBSs or a generation of the RAT of the respective one of the RBSs; a timespan spent by the at least one radio device camped on a cell of the respective one of the RBSs; a timespan spent by the at least one radio device detached from a cell of the respective one RBSs; a data rate profile of the at least one radio device in a cell of the respective one RBSs; and a change of a data rate profile of the at least one radio device in a cell of the respective one RBSs.

The change of the data rate profile of the at least one radio device may be determined based on a comparison with a historical data rate profile (e.g., stored at the respective radio device or the respective one of the RBSs) of the same radio device in another cell or the same cell (e.g., caused by interference of the fake RBS).

The training of the neural network (e.g., according to the method aspect) may further comprise or initiate the step, optionally performed by an operation administration and management (OAM) module, of receiving at least one measurement report indicative of the at least one observation of the at least one radio device.

The at least one observation may be received from a RBS serving the at least one radio device. The serving RBS may be different from the respective one of the RBSs referenced in the at least one observation.

The method (e.g., according to the method aspect) may further comprise or initiate the step of anonymizing the states of the experiences by replacing observations that are indicative of an operator of the RAN or of the at least one radio device by a geographical information indicative of a location of the respective one of the RBSs or the at least one radio device. The method (e.g., according to the method aspect) may further comprise or initiate the step of translating the cell-ID of the received at least one observation to a latitude and a longitude of the respective one of the RBSs. The method (e.g., according to the method aspect) may further comprise or initiate the step of translating the at least one IMSI of the received at least one observation to a latitude and a longitude of the at least one radio device.

The method (e.g., according to the method aspect) may further comprise or initiate augmenting the received at least one observation with network information of the RAN. The network information comprising at least one of a latitude of the respective of one of the at least one radio device or a latitude of a cell of the respective one of the RBSs; a longitude of the respective of one of the at least one radio device or a longitude of a cell of the respective one of the RBSs; a RAT of the respective one of the RBSs or a generation of the RAT of the respective one of the RBSs; a timespan spent by the at least one radio device camped on a cell of the respective one of the RBSs; a timespan spent by the at least one radio device detached from a cell of the respective one RBSs; a data rate profile of the at least one radio device in a cell of the respective one RBSs; and a change of a data rate profile of the at least one radio device in a cell of the respective one RBSs.

The state relative to the respective one of the RBSs (e.g., according to the method aspect) may be based on multiple observations of multiple radio devices. The method (e.g., according to the method aspect) may further comprise or initiate the step of combining the multiple observations relative to the respective one of the RBSs into the state relative to the respective one of the RBSs.

The step of combining may be performed by the OAM module. The combining may comprise averaging (or taking the median of) the multiple observations (of corresponding quantity of the observations).

The method (e.g., according to the method aspect) may further comprise or initiate the step of storing, in a distributed database (DD), the states relating to the plurality of RBSs or the states relating to all of the RBSs of the operator.

The step of storing the state may be performed by a network exposure function (NEF). Alternatively or in addition, the method may further comprise or initiate a step of storing the states relating to the respective one of the RBSs in a local memory.

The training (e.g., according to the method aspect) may comprise sending, to the FRD module, the states relating to the plurality of RBSs or the states relating to all of the RBSs of the operator.

The OAM module may perform at least one of the receiving of the at least one measurement report, the anonymizing of the states of the experiences, the translating of the cell-ID, the translating of the at least one IMSI, the augmenting of the received at least one observation, the combining of the multiple observations, the storing of the states in the DD, and the sending of the states to the FRD module.

The OAM module (e.g., a node) may be an operation support system (OSS, e.g., an Ericsson Network Manager, ENM).

From the radio network perspective, the OAM module may have full observability of the radio devices' (e.g., user equipments (UEs)) behaviors across multiple RBSs in the radio network. The OAM module may obtain radio device observations (e.g., data report) over time and store them in local memory (e.g., a shared memory, e.g. memory shared with the FRD module).

The OAM may be in communication with at least one of the FRD module and the DD. The step of sending the states relative to the respective one of the RBSs to the FRD module may be performed by the OAM module.

The location of the RBS may further be obtained from the RSRP and/or RSRQ, optionally by the OAM module. The transmission power of the RBSs may be compared with the RSRP and/or RSRQ.

The action (e.g., according to the method aspect) may be a result of a random choice or a forward pass of the neural network (e.g., by applying the state to the neural network), e.g. according to a selection policy.

The neural network may maximize the reward (R) over time in the training step. The neural network, in the training step, may try different possible actions (A) and store the resulting reward (R). The neural network may calculate a selection policy (e.g., a policy with maximum reward) based on the stored rewards (R).

The selection policy (e.g., policy) may be understood as a strategy that the neural network (NN) or the core node (e.g., also referred to as an agent for the training) uses in pursuit of its goals (e.g., detecting a fake RBS). The selection policy may be defined in terms of a Markov Decision Process to which the selection policy refers. Alternatively or in addition, the selection policy may be understood as a map (e.g., implemented by a q-table) that maps the states to the actions.

The training step of the method may comprise (e.g., according to the selection policy) exploring (e.g., try different possible actions) and learn from the outcomes of the actions (e.g., rewards) directly. Alternatively or in addition, the training step of the method may comprise (e.g., according to the selection policy) exploiting (or may comprise to selectively switch between exploring and exploiting). Exploiting may comprise choosing an action (A) based on its prior knowledge of the environment (e.g., a q-table of the reinforcement learning) to get a maximum direct reward (R). Alternatively or in addition, the training step of the method may comprise (e.g., according to the selection policy) keeping a balance between exploration (e.g. improving its current knowledge) and exploitation (e.g., a greedy or an epsilon-greedy policy).

The selection policy (e.g., according to the method aspect) may be changed during the training of the neural network based on a predefined accuracy.

The selection policy may be adjustable (e.g., tunable) in a training phase (e.g., in the training step) of the reinforcement learning of the neural network to reach and/or converge to a predefined optimal value. For example, the epsilon value of the epsilon-greedy policy may be changed.

The training step of the neural network in the FRD module (e.g., according to the method aspect) may end based on at least one of the set of experiences has been used for the training of the neural network or a predefined number of experiences has been used for the training of the neural network; an accuracy or a learning curve or a loss function of the neural network converged to a predefined value after training the neural network using a number of the experiences; a training loss of the neural network converged to a predefined value with a number of experiences; and a validation loss the neural network converged to a predefined value with a number of experiences.

The set of experiences may be referred to at least one of a subset of experiences based on the received states by the FRD module from the OAM module (e.g., according to a period of time); and/or a full set of experiences based on the all received states by the FRD module from the OAM module.

The learning curve may be represented by a prediction accuracy (or error rate) as a function of an amount or size of the training data (e.g., a number of the set of experiences used for the training). For example, the prediction accuracy may be indicative of how well the neural network predicts the target (e.g., detect a fake RBS) as the number of instances (e.g., experiences) used to training the neural network increases.

The loss function over time of the neural network may be indicative of how often the neural network fails to detect a fake RBS.

The accuracy over time of the neural network may be (e.g., understood as or indicative of) how accurate the neural network detects a fake RBS.

The training loss may be (e.g., understood as or indicative of) how well the neural network is fitting the training data. The validation loss may be understood as how well the neural network fits training data that has not yet been used for the training of the neural network (e.g., experiences of another operator retrieved from the DD).

The method (e.g., according to the method aspect) may further comprise or initiate the step, optionally performed by the OAM module, of storing the set of experiences each comprising the state, the action, the reward, and the updated state, relative to the respective one RBS in the DD. The DD may be shared with a core node of at least one other operator of the RAN, optionally via a network exposure function (NEF) module.

The NEF module may be referred to as a service capability exposure function (SCEF) (e.g., in 4th Generation). The SCEF and/or NEF module may be a network element that securely exposes the servers and capabilities provided by 3GPP network interfaces. Some of the functions of SCEF include Non-IP data delivery (NIDD) for low power devices. A Diameter Signaling Router (DSR) may support capabilities of the SCEF and/or NEF module.

The NEF module may send experiences from the core node (e.g., the FRD module of the core node) of an operator to the DD. The experiences may be anonymized. The experiences may be used for training step (e.g., phase) or re-training step of the neural network in the FRD module of a core node of another operator of the RAN.

The training of the neural network (e.g., according to the method aspect) may further comprise or initiate the step of retrieving a plurality of experiences of a core node of at least one other operator from the DD for the training or a retraining, optionally via the NEF module and/or to the FRD module of the core node.

Alternatively or in addition, the NEF may retrieve the states of another operator, optionally anonymized states from the DD and send them to the FRD module for performing training and/or retraining step.

The training step may be done periodically (e.g., daily based or weekly based) and/or triggered to be done (e.g., appearing a new RBS and/or receiving new set of experiences, etc.).

The DD (e.g., according to the method aspect) may be a distributed ledger, optionally based on a block chain.

The method (e.g., according to the method aspect) may further comprise or initiate a step of storing neural network weights of the trained neural network of the FRD module of the core node of the operator in the DD, optionally via the NEF module.

The method (e.g., according to the method aspect) may further comprise or initiate a step of receiving neural network weights of a trained neural network of the FRD module of the core node of at least one other operator from the DD, optionally via the NEF module.

The NEF module may be in communication with the FRD module of the core node. The NEF may receive the neural network weights (e.g., weights) of the trained neural network (e.g., matrices of a neural network weights) from the FRD module of the core node of an operator (e.g., a network operator) and send the weights to the DD. Alternatively or in addition, the FRD module may use the received weights of trained neural network of the FRD module of the core node of another network operator for training and/or re-training and/or updating the neural network.

The neural network weights of a trained neural network of the FRD module of the core node of the operator may be used as initiating (or initial) weights for another operator's core node's neural network (e.g., before the training step) and/or improving (e.g., by shortening the training time) the training phase of another operator's core node.

The method (e.g., according to the method aspect) may further comprise or initiate a step of updating the neural network based on an average of the neural network weights of the neural network of FRD module of the core node of the operator and the received neural network weights of the neural network of FRD module of a core node of the at least one other operator from the DD.

Optionally, the neural network may freeze the already trained neural network layers to not be changed and add new neural network layers with the received neural network weights from the DD.

The training of the neural network of the FRD module (e.g., according to the method aspect) may use at least one of an associative reinforcement learning; a deep reinforcement learning; q-learning; deep q-learning; a deep q-learning reinforcement learning algorithm; double deep q-learning or a double deep q-learning reinforcement learning algorithm; an actor critic reinforcement learning algorithm; a federated learning (FL); a safe reinforcement learning, and a partially supervised reinforcement learning.

The neural network may comprise a training prediction network and a target network. The target network may provide a ground truth for the training of the training prediction network, e.g., based on those experiences related to the operator. The target network may be updated based on a combination of the neural network weights of the training prediction network and the neural network weights received from the at least one other operator.

Alternatively or in addition, an algorithm and/or a selection policy used for the training may change in re-training and/or updating.

The operating of the neural network for detecting a fake RBS (e.g., according to the method aspect) may result in a report that is indicative of a presence of at least one fake RBS in the RAN.

Alternatively or in addition, the report may indicate the negative presence (absence) of a fake RBS in the RAN.

The report (e.g., according to the method aspect) may be sent to a third party, optionally by the NEF module. The third party may be at least one of a radio device served by the RAN; a or the DD, optionally wherein at least a core node of another operator has at least read access to the report; and an enterprise customer.

Herein, the words “a or the” feature may refer to a feature as such or the feature as defined above.

The NEF module and/or the SCEF may be in communication with the DD and/or may read the reports indicating the presence of a fake RBS. The NEF module and/or the SCEF and/or the OAM module may inform (e.g., the user of) the one or more radio devices in proximity of the detected fake RBS of the potential danger. Alternatively or in addition, it may further reveal (e.g., by broadcasting) the cell-ID of the detected fake RBS to the RDs.

Alternatively or in addition, other entities (e.g., law enforcement) may participate in the DD, e.g., by having “read access” to the DD, so that they can detect and/or identify the fake RBSs reported by the core node (or the operators).

The training and the operating of the neural network (e.g., according to the method aspect) may be performed simultaneously and/or partially at the same time.

The operating step may be performed after the training step ends. Alternatively or in addition, the operating step and the training step performed simultaneously. Alternatively or in addition, the operating step starts before the training step ends.

The operating of the neural network (e.g., according to the method aspect) may be performed continuously and/or periodically and/or triggered, e.g. by at least one of a subscription observation from at least one new radio device; a control message from a mobility management entity (MME); a public safety message indicative of safety event in an area, optionally wherein the FRD evaluates the presence of a fake RBS in the area; and a public safety message indicative of a temporal public safety event.

As to a device aspect, a core node of an operator is provided. The core node comprises a fake radio base station detector (FRD) module for detecting a fake radio base station (RBS), in a radio access network (RAN) comprising a plurality of RBSs. The core node comprises memory operable to store instructions and processing circuitry operable to execute the instructions, such that the core node is operable to train a neural network in the FRD module according to reinforcement learning with a set of experiences. Each of the experiences relates to one of the RBSs and comprises a state based on at least one observation of at least one radio device (RD) relative to the respective one of the RBSs, an action indicative of a degree of trust whether the respective one of the RBSs is a fake RBS, an updated state for the respective one of the RBSs, and a reward based on a likelihood function. The reward is indicative of a correlation between the action and the likelihood function for the respective one of the RBSs being a fake RBS based on the respective one of the states. The likelihood function is determined by the core node based on the at least one observation of the at least one radio device relative to the respective one of the RBSs. The core node is further operable to operate the neural network for detecting a fake RBS.

The core node (e.g., according to the device aspect) may further comprise a network exposure function (NEF) module and/or an operation administration and management (OAM) module.

Alternatively or in addition, the core node (e.g., according to the device aspect) may further be operable to perform any one of the steps of the method aspect.

As to a further device aspect, a core node of an operator is provided. The core node comprises a fake radio base station detector (FRD) module for detecting a fake radio base station (RBS) in a radio access network (RAN) comprising a plurality of RBSs. The core node is configured to train a neural network in the FRD module according to reinforcement learning with a set of experiences. Each of the experiences relates to one of the RBSs and comprises a state based on at least one observation of at least one radio device (RD) relative to the respective one of the RBSs, an action indicative of a degree of trust whether the respective one of the RBSs is a fake RBS, an updated state for the respective one of the RBSs, and a reward based on a likelihood function. The reward is indicative of a correlation between the action and the likelihood function for the respective one RBS being a fake RBS based on the respective one of the states. The likelihood function is determined by the core node based on the at least one observation of the at least one radio device relative to the respective one of the RBSs. The core node is further configured to operate the neural network for detecting a fake RBS.

The core node (e.g., according to the device aspect) may further comprise a network exposure function (NEF) module and/or an operation administration and management (OAM) module.

Alternatively or in addition, the core node (e.g., according to the device aspect) may further be configured to perform any one of the steps of the method aspect.

As to a system aspect, a communication system is provided. The communication system comprising a radio access network (RAN) comprising a plurality of RBSs; at least one core node of at least one operator, each of the at least one core node comprising a fake radio base station detector (FRD) module for detecting a fake RBS in the RAN according to the device aspect; and a distributed database (DD), in data communication with the least one core node.

The communication system may further comprise at least one radio device in radio connection with at least one of the RBSs.

The at least one core node (e.g., according to the system aspect) may further comprise at least one of an NEF module and an OAM module.

The communication system (e.g., according to the system aspect) may further comprise an interface to a third party. The interface may be configured to send, as the result of the operating, a report from the core node indicative of the presence of a fake RBS in the RAN, optionally sent via the NEF or the DD. The third party may be at least one of a radio device served by the RAN; an operation and maintenance (OAM) node of at least one other operator, optionally having at least read access to the report in the DD; and an enterprise customer.

The communication system may further comprise any feature and/or may be configured to perform any step disclosed in the context of any one of the method aspect and the device aspects.

The technique may be applied in the context of 3GPP Long Term Evolution (LTE) and/or New Radio (NR).

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a still further aspect a communication system including a host computer is provided. The host computer comprises a processing circuitry configured to provide user data. The host computer further comprises a communication interface configured to forward the first and/or second data to a cellular network (e.g., the RAN and/or the base station) for transmission to a UE. A processing circuitry of the cellular network is configured to execute any one of the steps of the method aspect. Alternatively or in addition, the UE comprises a radio interface and processing circuitry, which is configured to execute any one of the steps of the radio device disclosed herein.

The communication system may further include the UE. Alternatively, or in addition, the cellular network may further include one or more base stations (i.e., RBSs) configured for radio communication with the UE and/or to provide a data link between the UE and the host computer using the method aspect.

The processing circuitry of the host computer may be configured to execute a host application, thereby providing the user data and/or any host computer functionality described herein. Alternatively, or in addition, the processing circuitry of the UE may be configured to execute a client application associated with the host application.

### BRIEF DESCRIPTION OF THE DRAWINGS

Further details of embodiments of the technique are described with reference to the enclosed drawings, wherein:

FIG. 1 shows a schematic block diagram of an embodiment of a device for detecting a fake radio base station;

FIG. 2 shows a schematic block diagram of an embodiment of a system for detecting a fake radio base station;

FIG. 3 shows a flowchart for a method of detecting a fake radio base station, which method may be implementable by the device of FIG. 1;

FIG. 4 schematically illustrates a first example of a radio access network comprising radio base stations of different operator for performing the method of FIG. 3;

FIG. 5 schematically illustrates a second example of a radio access network comprising two operators comprising embodiments of the devices of FIGS. 1 and 2, for performing the method of FIG. 3;

FIG. 6 schematically illustrates a sequence diagram for detecting a fake radio base station according to the method of FIG. 3;

FIG. 7 schematically illustrates an example of a sequence diagram for detecting a fake radio base station according to the method of FIG. 3, wherein the neural network uses double deep q-learning algorithm;

FIGS. 7a, 7b, 7c, and 7d schematically illustrates exemplary sections of the sequence diagram for detecting a fake radio base station according to the FIG. 7 in more details;

FIG. 8 shows a schematic block diagram of a core node embodying the device of FIG. 1;

FIG. 9 shows a schematic block diagram of a core network embodying the device of FIG. 1;

FIG. 10 schematically illustrates an example telecommunication network connected via an intermediate network to a host computer;

FIG. 11 shows a generalized block diagram of a host computer communicating via a base station or radio device functioning as a gateway with a user equipment over a partially wireless connection; and

FIGS. 12 and 13 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

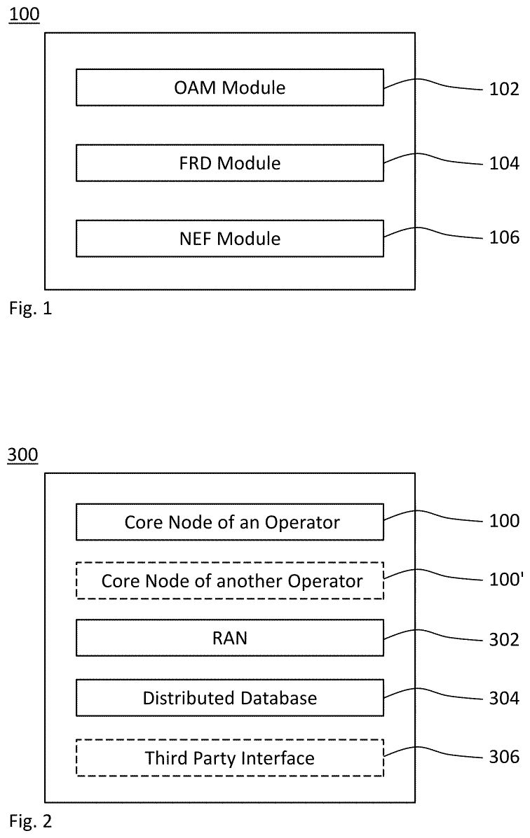

FIG. 1 schematically illustrates a block diagram of an embodiment of a device for detecting a fake radio base station (RBS, e.g., base station, or network node) in a radio access network (RAN, briefly: radio network). The device is generically referred to by reference sign 100. The device may also be referred to as, or may be embodied by, the core node (e.g., core network). The core node 100 may be a core node of an operator 38. The RAN may comprise one or more operators (e.g., network operators). Each of the operators 38 and/or 39 may comprise one or more RBSs 32.

Any one, or combination, of the modules 102, 104 and 106 may perform at least one of the training step and the operating step according to the method aspect.

The RAN operators may use 4G and/or 5G radio access technology (RAT). Whenever referring to the RAN, the RAN may be implemented by one or more base stations. Alternatively or in addition, the radio network may be a vehicular, ad hoc and/or mesh network comprising two or more radio devices (RDs) 36. The RAN may be implemented according to the Global System for Mobile Communications (GSM), the Universal Mobile Telecommunications System (UMTS), 3GPP Long Term Evolution (LTE) and/or 3GPP New Radio (NR).

The base station 32 may encompass any station that is configured to provide radio access to any of the RDs 36. The base stations 32 may also be referred to as cell, transmission and reception point (TRP), radio access node or access point (AP). Examples for the network node (e.g., base station) may include a 3G base station or Node B (NB), 4G base station or eNodeB (eNB), a 5G base station or gNodeB (gNB), a Wi-Fi AP, and a network controller (e.g., according to Bluetooth, ZigBee or Z-Wave).

The operator 38 may comprise a plurality of RBSs and a core node 100. The core node 100 may be in radio and/or wired communication with one or more of the RBSs 32 of one or more operators 38 and/or 39. The core node may further be referred to as Network Data Analytics Function (NWDAF).

Any RD 36 may be a user equipment (UE), e.g., according to a 3GPP specification. Any of the RDs 36 may be a 3GPP user equipment (UE) or a Wi-Fi station (STA). The RD 36 may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

The RD 36 may report the at least one observation, e.g. to its serving RBS 32. The observation of the at least one RD 36 may comprise at least one of a channel quality of a radio channel between the at least one RD 36 and the respective one of the RBSs 32, a RSRP measured in the RD 36, a RSRQ measured in the RD 36, at least one IMSI of the radio device 36, a cell-ID of a cell of the respective one of the RBSs 32, a latitude of the respective of one of the radio device 36 or a latitude of a cell of the respective one of the RBSs 32, a longitude of the respective of one of the radio device 36 or a longitude of a cell of the respective one of the RBSs 32, RAT of the respective one of the RBSs 32 or a generation of the RAT of the respective one of the RBSs 32, a timespan spent by the RD 36 camped in a cell of the respective one RBS 32, a timespan spent by the RD 36 detached from a cell of the respective one of the RBS 32, a data profile of the RD 36 in a cell of the respective one of the RBSs 32, and a change of a data rate profile of the RD 36 in a cell of the respective one RBSs 32. In other words, the core node 100 may receive an observation report indicative of the at least one observation from the at least one RD relative to one or more RBSs 32.

Herein, the fake RBS 34 may be one of the plurality of RBSs 32.

The core node 100 may comprise an operation administration management (OAM) module 102. The OAM module 102 may receive one or more observations of the at least one RDs 36. The OAM module 102 may further process the received observations. The OAM module 102 may translate the cell-ID from the received observation to latitude and longitude. This geographical information may be available to the OAM module 102, as it is stored in some database in the mobile network operator that OAM has access to (e.g., the Unified Data Management—UDM node). The OAM module 102 may obtain the location of the RBS 32 based on the RSRP and/or RSRQ of the received observation. The OAM module 102 may further use the location of the RBSs 32 for example for verification of the cell locations and/or distances between the RSBs 32.

Alternatively or in addition, the OAM module 102 may augment the received observations with network information (e.g., information about RBSs of the operator and the further reports from the at least one RD). Since the OAM module 102 has full observability of a RD 36 behavior across multiple RBSs in the RAN (e.g., mobile network), it is able to augment the received RD 36 observations regarding at least one of:
The periods of disappearance from the network (e.g., RBSs 32), i.e., the times that the RD 36 stays detached from the RAN. For example, in case the detachment times are too frequent and/or too geographically concentrated, this may indicate presence of a fake RBS 34.
The periods of the RD 36 camping on a lower generation RAT, e.g., 2G in areas where 3G, 4G or 5G coverage is offered combined with the RD 36 having capability to use higher generation of RATs. This feature can be used in tandem with the above feature optionally, as it requires logging capabilities on the RD 36 side.
The traffic profile of the RD 36 (e.g., data rate), meaning whether reaching achieved levels of latency and throughput, but also denial of service for part of or all destinations the RD 36 tries to reach. This feature requires logging capabilities on the RD 36 side but may be a useful feature for detecting presence of a fake RBS 34.

The RD 36 may be able to provide more data (e.g., battery status, location, type of RAT used, etc. for machine learning neural network) in the report observation that may enable feasibility to report more of such data to be used in the OAM module 102 for augmentation.

The OAM module 102 may further classify (e.g., combine) RD 32 observations corresponding to an RBS to a state. The OAM module 102 may anonymize the states (e.g., by removing the RD-specific data and/or operator-specific data and/or identifiers). The OAM module 102 may store the states in the local memory (e.g., internal memory of the core node 100). The OAM module 102 may further store the states to a distributed database (DD) 304.

The core node 100 comprises an FRD module 104. The FRD module 104 may be in communication with the OAM module 102. The OAM module 102 may send the states to the FRD module 104. The FRD 104 may receive the states from the OAM module 102. The FRD module 104 may process the received states (e.g., observations) from the OAM module 102 to detect a fake RBS 34.

The FRD 104 may comprise a neural network (NN). The NN may have a training phase (e.g., training step) and an operating phase (e.g., operating step). The operating phase may be temporally after the training phase and/or simultaneously with the training phase and/or starting before the training phase ends. The NN may use one or more algorithms (e.g., reinforcement algorithm) to perform training phase. The weights and/or the bias may be learnable (e.g., trainable), i.e. may be changed in the step of training according to the reinforcement learning (RL) based on the training data (e.g., experiences).

The NN may use a single-agent (e.g., deep) reinforcement learning process. The NN of the FRD module may use the received states (e.g., observations) from the OAM module 102 for training phase.

As an example of an observation may be an anonymized observation of RDs 36 into cell-specific (e.g., related to a specific RBS 32) observation and/or an augmented observation of the RD 36 with the network information in the OAM module 102. The observation may be a list of information: [cellID, latitude, longitude, RSRP, RSRQ, RAT, timespan spent camped at the cell], e.g., [200123423, 43.4345, 54.43455, −75, −5, GSM, {[2011-11-11 11:11-2011-11-11 12:12], [2011-11-11 12:15, 2011-11-11 12:18]}]. For example, the timespan spent in the cell (e.g., timestamp information) may have been added to the RD 36 report and/or augmented later at OAM module 102 and/or in the FRD module once the observations (e.g., states) has been received from the OAM module 102.

The NN may receive the state (e.g., state description) from the OAM module 102. The state may be one or more observations (e.g., considering the cell-ID latitude and longitude static, and RSRP and RSRQ may be averaged and aggregated over timespans).

The purpose of RL is for the NN (e.g., machine) to learn an optimal, or nearly optimal, policy that maximize a “reward function” (e.g., reward). In the exemplary embodiment that may be combined with other embodiments, the NN (e.g., agent) observe a current environment state (e.g., receive the states from the OAM module 102). In this case the problem to be solved is if the state received from the OAM module 102 is due to a fake RBS 34 or a real RBS 32. The NN take an action (A), i.e., make a decision that the corresponding RBS 32 is fake or not. The NN may be rewarded (R) based on the taken action (A) and a predefined likelihood function (briefly: likelihood) for the corresponding RBS 32 being a fake RBS 34 or not.

The likelihood (L) is determined by the core node 100 based on the at least one observation of the at least one RD 36.

The L may be the probability for the respective RBS 32 being a fake RBS 34 or not.

The L may be any number between 0 and 1 (e.g., in the interval [0, 1]). The L may be computed based on a mathematical function of at least one observation of a RD 36 relative to an RBS 32. The observation may comprise more than one parameters (e.g., RSRP, RSRQ, and etc.). The observation parameter may be for example a radio access technology (RAT) of the RBS 32, a timespan the UE spent camped on the coverage network cell of the RBS, a timespan the UE was detached from the RBS, and etc. The mathematical function of L may comprise a coefficient corresponding to each observation parameters. The coefficients may be predefined coefficients and/or chosen based on the experimental validations and/or dynamic coefficients.

As for an example, without limitation, the likelihood may be a function L, e.g. as defined below:

$$L = [ \begin{matrix}{w}_{RSRP} \cdot \frac{- 80}{RSRP} + {w}_{RSRQ} \cdot \frac{- 10}{RSRQ} + {w}_{CAMP} \cdot \\ ( \frac{( {\sum }_{i = 1}^{x} {camp}_{i} \cdot end - {camp}_{i} \cdot begin )}{{camp}_{x} \cdot end - {camp}_{1} \cdot begin} ) + {w}_{DETACH} \cdot \\ ( \frac{( {\sum }_{i = 1}^{k} {detach}_{i} \cdot end - {detach}_{i} \cdot begin )}{{detach}_{k} \cdot end - {detach}_{1} \cdot begin} ) + {w}_{THR} \cdot \\ ( 1 - \frac{\vert {thr}_{UEcurrentUL} - {thr}_{UEhistUl} ) \vert}{max ( t h {r}_{UEcurrentUL} , {thr}_{UEhistUL} )} ) + \\ \frac{( 1 - \frac{\vert {thr}_{UEcurrentDL} - {thr}_{UEhistDL} ) \vert}{max ( {thr}_{UEcurrentDL} , {thr}_{UEhistDL} )} )}{2}\end{matrix} ]$$

In the above formula all coefficients (e.g., W's) may sum up to 1 (e.g., in case L may be referred to as the probability of the respective RBS 32 being a fake RBS 34). Alternatively or in addition, the L may be based on channel quality key performance indicators (KPIs) (e.g., measured in terms of RSRP and/or RSRQ, cell camping, number detaches per time and/or length of attach periods, throughput, etc.).

The likelihood may be used by the FRD module 104 (e.g., NN) as basis for training the neural network according to the reinforcement learning. The NN may take an action (A) i.e., predict if the respective RBS is a fake RBS or not, based on the received state. The action may have a numerical representation. The numerical representation may be binary action space for trusted and not trusted (e.g., −1 corresponds to a real RBS 32 and 1 corresponds to a fake RBS 34) and/or varying degrees of trust (e.g., a scale ranging from 1 to 5).

The NN may be rewarded and/or punished (e.g., negatively rewarded) based on the taken action (A) and the likelihood (L). The R may be indicative of “how effective the taken action (A) was” in comparison with the L. The R may have an upper and lower bound. As for an example, without limitation, the R may be calculated as following:

$$R = \{ \begin{matrix}L & if A = 1 \\ 1 - L & if A = - 1\end{matrix}$$

The action A is e.g., 1 if the RBS predicted to be a fake RBS and −1 if the RBS was predicted to be real.

According to the example, if the L for an RBS being a fake RBS is L=0.7 and the taken action is A=1 (e.g., in binary action space, A=1 corresponds to a fake RBS), the reward would be R=0.7, and if the taken action for the same likelihood is A=−1 (e.g., in binary action space, A=−1 corresponds to a real RBS), the reward (e.g., punishment) would be R=−0.3. The reward may indicate how effective the action was.

The goal of the training neural network according to the RL is to learn a policy that maximize the expected cumulative reward. The neural network may maximize the reward (R) over time in training step. The neural network, in the training 202, may try different possible actions and store the reward (R) results. The neural network may calculate a selection policy (e.g., a policy with maximum reward) based on the stored reward (R) results. The advantage of using the RL is this technique is independent of having a data sample for training step that is labeled with the ground truth.

The calculated reward R may be returned together with the state to the FRD module 104. The FRD module 104 may be stored a 4-tuple <state, action, reward, updated state>, which is also referred to as 4-tuple experience (e.g., experience), to a local memory. The FRD module 104 may further store the experiences in the distributed database (DD) 304. The NN may receive one or more states and take an action accordingly and being rewarded based on the taken action and the likelihood of the corresponding RBS 32 being a fake RBS 34 or not.

The plurality of the experiences (e.g., relative to a core node, optionally including experiences received from a core node of one other operator) may be referred to as training data. The experiences may be understood as a Markov decision process (e.g., a four tuple form).

The neural network may choose random values for the weight and/or the bias values before the training phase begins. As the training step starts, the weight and/or the bias associated with each node may be adjusted toward the desired values (e.g., predefined values) and the correct output. For example, the weight and/or the bias associated with each node may be change after input each experience of the set of experiences.

Alternatively or in addition, after the training phase the weights and/or bias associated with each node of the NN converge (e.g., will not change). Alternatively or in addition, the weights and/or bias associated with each node of the NN may further change in case of re-training phase and/or operating phase (e.g., the weights and/or bias may converge in higher accuracy).

The training phase of the NN in the FRD module 104 may end based on an iteration over the set of experiences. The set of experiences may be referred to at least one of a subset of experiences based on the received states by the FRD from the OAM (e.g., according to a period of time); and/or a full set of experiences based on the all received states by the FRD from the OAM.

The core node 100 (e.g., the FRD module 104) may store the weights (e.g., neural network weights) of the trained NN in the DD 304. Alternatively or in addition, the core node 100 (e.g., the FRD module 104) may receive (e.g., retrieve) neural network weights of a trained NN of an FRD of a core node of at least one other operator 39 in the RAN from the DD 304.

The core node 100 may further comprise a network exposure function (NEF) module 106. The NEF module 106 may send experiences from the core node 100 (e.g., the FRD 104 of the core node 100) of an operator 38 to the DD 304. The experiences may be used for training step (e.g., phase) or re-training step of a neural network in the FRD 104 of core node 100 of another operator 39. Alternatively or in addition, the NEF module 106 may send the states of a core node 100, optionally anonymized states, to the DD 304. The NEF module 106 may further send to/receive from the DD 304 the neural network weight.

Alternatively or in addition, the NEF module 106 may receive the experiences of at least another operator 39 of the RAN from the DD 304 to the core node 100 (e.g., the FRD module 104 of the core node 100). Alternatively or in addition, the NEF module 106 may retrieve the states of another operator 39, optionally anonymized states from the DD 304 and send them to the FRD module 104 for performing training and/or retraining phase (e.g., step).

Alternatively or in addition, the core node 100 may update the NN based on an average of the weights of the NN of FRD module 104 of the core node 100 of the operator 38 and the received weights of the NN of FRD of another core node 100 of at least another operator 39 from the DD 304.

The shared training data between core nodes 100 of operators 38 and/or 39 may improve the training of the NN and/or decreasing the training time. The shared training data between core nodes 100 of operators 38 and/or 39 may increase the accuracy of the detecting a fake RBS 34.

The OAM module 102 and the FRD module 104 and the NEF module 106 may be in communication with each other.

The FRD module 104 may detect a fake RBS 34. The FRD module 104 may use the NN (e.g., trained NN according to the RL) to detect a fake RBS 34, e.g., in operating phase (e.g., step). The detection of a fake RBS 34 may result a report indicative of a presence of a fake RBS 34 in the RAN.

The report may comprise the position (e.g., location) of the fake RBS 34. The report may be sent to a third party, optionally by the NEF module 106. The third party may be at least one of a RD 36, a DD 304, and an enterprise customer. The report to the at least one RD 36 may be sent by the OAM module 102. The third party may be in communication with the DD 304 and has a read access to the report.

The NEF module (e.g., the SCEF) may be in communication with the DD 304 and may read the reports indicating the detected fake RBSs 34. The NEF module and/or the OAM module may inform the owner of the RDs 36 in proximity of the fake RBS 34 of the potential danger. Alternatively or in addition, they may further reveal the broadcasted cell-ID of the fake RBS 34 to the RDs 36.

Alternatively or in addition, other entities (e.g., law enforcement) may participate in the same DD 304 and have “read access” to it, so they can detect and suppress the fake RBSs 34 reported by the operators 38 and/or 39.

Alternatively or in addition, the operating phase may be continuous and/or periodically and/or triggered by at least one of a subscription observation from the owner of a RD 36 to update on potentially fake RBSs 34, a mobility management entity (MME), a spatial public safety, and a temporal public safety.

Any of the modules of the device 100 may be implemented by units configured to provide the corresponding functionality.

The device comprises processing circuitry (e.g., at least one processor and a memory). Said memory comprises instructions executable by said at least one processor whereby the device is operative to perform any one of the steps of the method aspect.

FIG. 2 schematically illustrates a block diagram of an embodiment of a system 300 for detecting a fake RBS 34 in a RAN comprising a plurality of RBSs 32.

The system 300 (e.g., a communication system) may comprise at least one core node 100 and/or 100′ according to the FIG. 1 and/or the device aspect. The core node 100 may be related to the operator 38. The core node 100′ may be related to the operator 39. The core nodes 100 and/or 100′ may comprise an FRD module 104 comprising a neural network for detecting a fake RBS 34.

The system 300 further comprises at least one RAN operator 302 and/or 38 and/or 39 comprising at least one RBS 32 and at least one RD 36 in radio connection to the RBS 32.

The system 300 further comprises a distributed database (DD) 304. The DD 304 may be in communication with at least one core node 100 of at least one operator 302 and/or 38 and/or 39. The DD 304 may be a memory using any available technology. The DD 304 may be a distributed ledger, optionally based on a block chain. The block chain technology has many advantages such as enhanced security, greater transparency, instant traceability, increased efficiency and speed, and automation.

The system 300 may optionally comprise a third party or a corresponding interface 306 for a third party. The third party interface 306 may be in communication with the core node 100 and/or the DD 304. The third party may receive the reports indicating the presence of a fake RBS 34. Alternatively or in addition, the third party may have read access to the DD 304 to read the reports, e.g. in order to take an action according to a policy (e.g., regional policy due to the fake RBS presence) and/or suppress the one or more fake RBSs 34 reported by the core nodes 100.

Any one of the modules of the system 300 may be implemented by units configured to provide the corresponding functionality.

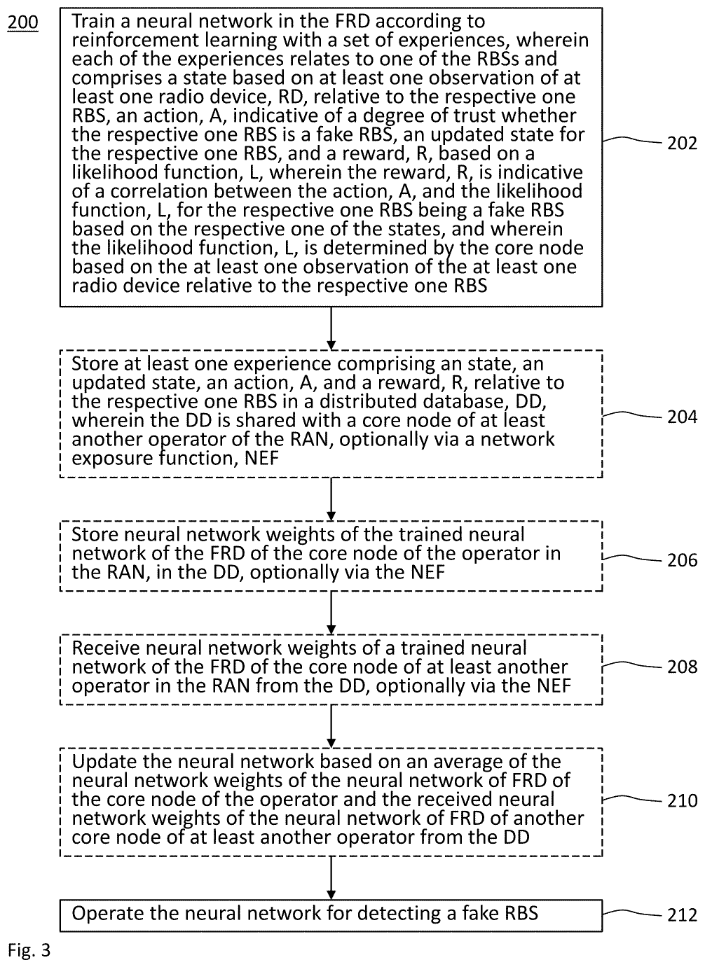

FIG. 3 shows an example flowchart for a method 200 performed by a core node 100 of an operator 38, e.g. according to the FIG. 1. The core node 100 may comprise a fake radio base station detector (FRD) 104 for detecting a fake RBS 34 in a RAN comprising a plurality of RBSs 32.

In a step 202, the core node 100 trains a neural network in the FRD 104 according to reinforcement learning (RL) with a set of experiences. Each of the experiences relates to one of the RBSs 32 and comprises a state based on at least one observation of at least one RD 39 relative to the respective one RBS 32, an action (A) indicative of a degree of trust whether the respective one RBS 32 is a fake RBS 34, an updated state for the respective one RBS 32, and a reward (R) based on a likelihood function (L). The reward (R) may be indicative of a correlation between the A and the L for the respective one RBS 32 being a fake RBS 34 based on the respective one of the states. The L may be determined by the core node 100 based on the at least one observation of the at least one RD 36 relative to the respective one RBS 32.

The training step 202 of the NN may further comprise or initiate the step, optionally performed by an OAM module 102, of receiving at least one measurement report indicative of the at least one observation of the at least one RD 36.

The training step 202 of the NN may further comprise or initiate the step of anonymizing the states of the experiences by replacing observations that are indicative of an operator of the RAN or of the at least one RD 36 by a geographical information indicative of a location of the respective one of the RBSs 32 or the at least one RD 36; translating the cell-ID of the received at least one observation to a latitude and a longitude of the respective one of the RBSs 32; and translating the at least one IMSI of the received at least one observation to a latitude and a longitude of the at least one RD 36.

The training step 202 of the NN may further comprise or initiate the step of augmenting the received at least one observation with network information of the RAN. The training step 202 of the NN may further comprise or initiate the step of combining the multiple observations relative to the respective one of the RBSs 32 into the state relative to the respective one of the RBSs 32. The training step 202 of the NN may further comprise or initiate the step of sending, to the FRD module 104, the states relating to the plurality of RBSs 32 or the states relating to all of the RBSs 32 of the operator 38.

Optionally in step 204, the core node 100 may store at the set of experiences each comprising the state, the action, the reward, and the updated state, relative to the respective one RBS 32 in the DD 304. The DD 304 may be shared with a core node of at least one other operator 39 of the RAN, optionally via a NEF module 106.

Optionally in step 206, the core node 100 may store neural network weights of the trained 202 NN of the FRD 104 of the core node 100 of the operator 38 in the RAN, in the DD 304, optionally via the NEF 106.

Optionally in step 208, the core node 100 may receive neural network weights of a trained 202 neural network of the FRD 104 of the core node 100 of at least another operator 39 in the RAN from the DD 304, optionally via the NEF 106.

Optionally in step 210, the core node 100 may update the neural network based on an average of the weights of the NN of FRD 104 of the core node 100 of the operator 38 and the received neural network weights of the NN of FRD 104 of a core node 100′ of at least another operator 39 from the DD 304, optionally via the NEF 106.

In step 212, the core node 100 operate the NN for detecting a fake RBS 34.

The method 200 may be performed by the device 100. The steps 202 to 212 may operate simultaneously, and/or initiating before the previous steps end.

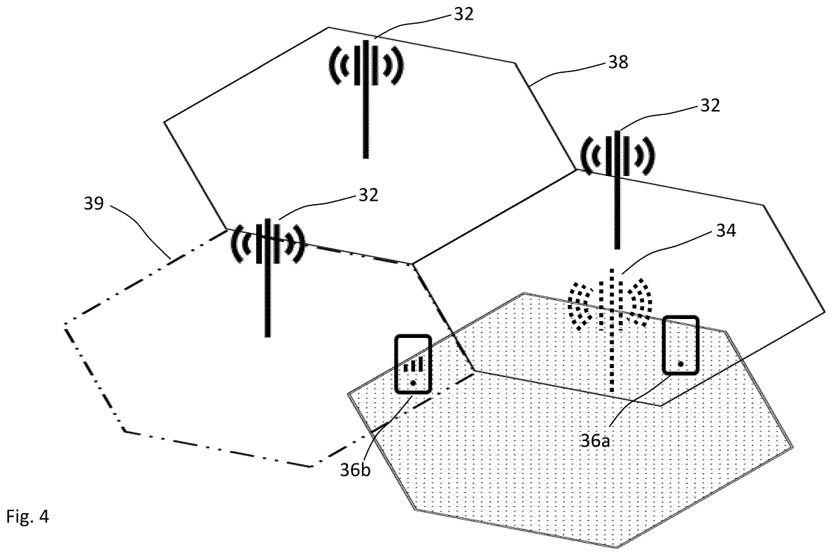

FIG. 4 shows an example for a method 200 according to the FIG. 2 of performed by the core node 100 of the operator 38 according to the FIGS. 1 and 2.

The operator 38 according to the FIG. 4 has two RBSs 32. Each of the RBSs 32 may have a coverage, i.e., cell, herein showed by straight line hexagons, and accordingly cell-IDs. In neighborhood of the cells of the operator 38, may be an RBS 32 related to another operator 39 with coverage herein showed by dash line hexagon. In the vicinity of the operators 38 and 39, a fake RBS 34 (herein showed by dash line) with coverage herein showed by shadowed hexagon.

The core node 100 of the operator 38 may receive observations from the RD 36a according to the RBS 32 and the RBS 34. The core node may operate the trained NN for detecting a fake RBS 34. The core node 100 of the operator 38 may send the report (e.g., comprising the presence of a fake RBS 34 and/or the location of the fake RBS 34) to the shared DD 304 between the operator 38 and the operator 39. The operator 39 may retrieve the report of the core node 100 of the operator.

Alternatively or in addition, the core node 100 of the operator 38 may store the training data (e.g., states and/or experiences) and/or the neural network weights of the trained 202 NN to the shared DD 304. The core node 100 of the operator 39 may retrieve the training data and/or the neural network weights of the trained NN from the shared DD 304. The core node 100′ of the operator 39 may re-train and/or update the NN of its core node using the received training data and/or the neural network weights.

Alternatively or in addition, the core node 100 may operate the NN for detecting a fake RBS 34 and may send a report, indicative of a presence of at least one fake RBS 34 in the RAN, to a third party (e.g., the DD 304). The core node 100′ of the one other operator 39 may read the report from the core node 100 of the operator 38 and react according to a predefined policy (e.g., suppressing the detected fake RBS 34).

Alternatively or in addition, the core node 100′ of the operator 39 may detect a fake RBS 34 and the core node 100 of the operator 38 may receive the report indicative of the presence of a fake RBS 34 in the RAN from the DD 304.

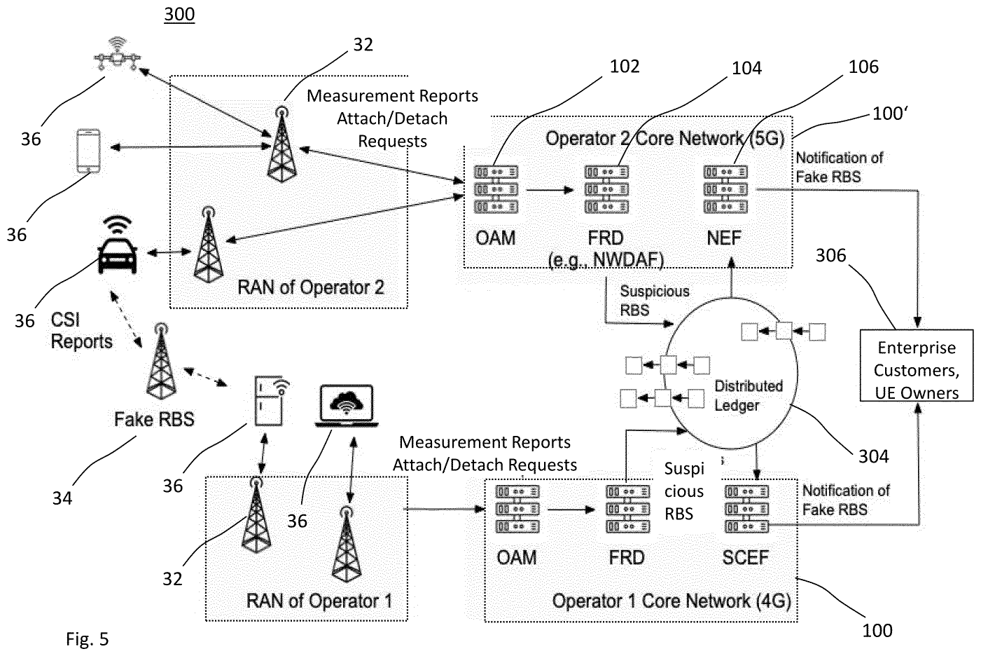

FIG. 5 shows an exemplary block component diagram, illustrating two operators 1 and 2, for detecting a fake RBS 34 (e.g., collaborating via sharing a DD 304). FIG. 5 illustrates the block components of the system 300 according to FIG. 2.

FIG. 5 shows a plurality of RDs 36 that may be connected to an RBS 32 according the RAN of operator 1 and/or the RAN of operator 2 and/or a fake RBS 36.

The RDs 36 may send the measurement reports (e.g., reports and/or observations comprising CSI reports) to the one or more RBSs 32. The one or more RBSs 32 may send the RD observations to the core node 100, optionally to the OAM module 102. The one or more RBSs 32 may send their measurement reports (e.g., attach/detach requests) to the core node 100, optionally to the OAM module 102.

The OAM module 102 may have full observability of the RDs behavior across multiple RBSs 32. The OAM module 102 may classify RD observations into the states, and may further anonymize the states, and may further augment the received states according to the network information, and may further send the states (e.g., observations) to the FRD module 104.

The FRD module 104 may comprise a NN and may train the NN according to reinforcement learning with a set of experiences. The experiences may comprise a state (e.g., received states from the OAM module 102), an action A, an updated state for the respective one RBS 32, and a reward R based on a likelihood function.

The core node 100 may be in communication with a DD 304, optionally via the NEF module 106 and/or the FRD module 104. The core node 100 may store the experiences (e.g., training data) in the DD 304, optionally via the FRD module 104 and/or the OAM module 102. The core node 100 may further receive the experiences according to one other operator 39 and/or 2.

The core node 100 (e.g., the FRD module 104) may operate the NN for detecting a fake RBS 34. The core node 100 may send a report of a fake RBS 34 presence as a result of NN operation to the DD 304. The core node 100′ may receive the report indicative of a fake RBS 34 presence from the DD 304. The core node 100 may further send the report of a fake RBS presence to a third party. The third party may be an RD 36 and/or an enterprise customer.

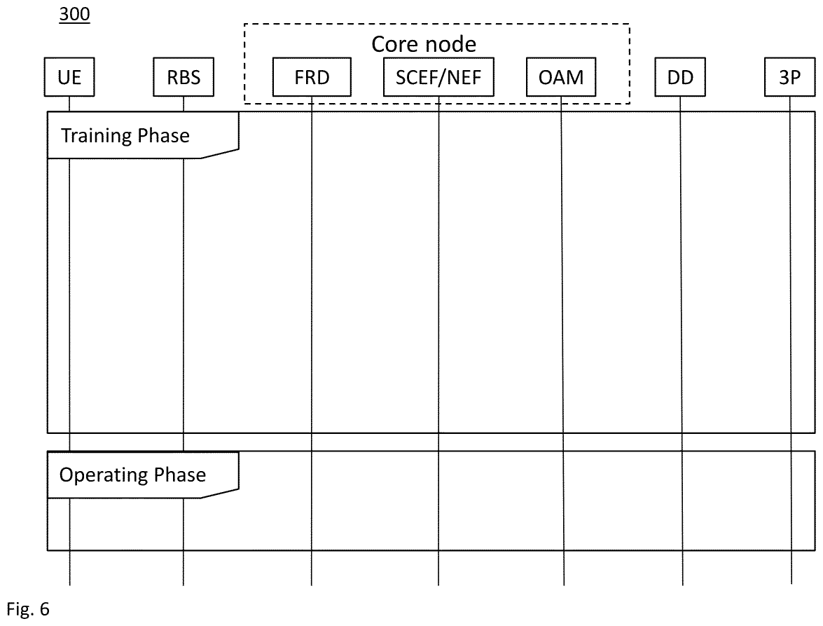

FIG. 6 schematically shows a sequence diagram for detecting a fake RBS 34 according to the method of FIG. 3. FIG. 6 shows the main data flow (e.g., messages) in the system according to the FIG. 2.

The first loop illustrates the training phase (e.g., step) of the NN to learn a policy for predicting presence of a fake RBS 34 (e.g., predicting on whether an RBS 32 reported by a RD 36 is a fake RBS 34 or not).

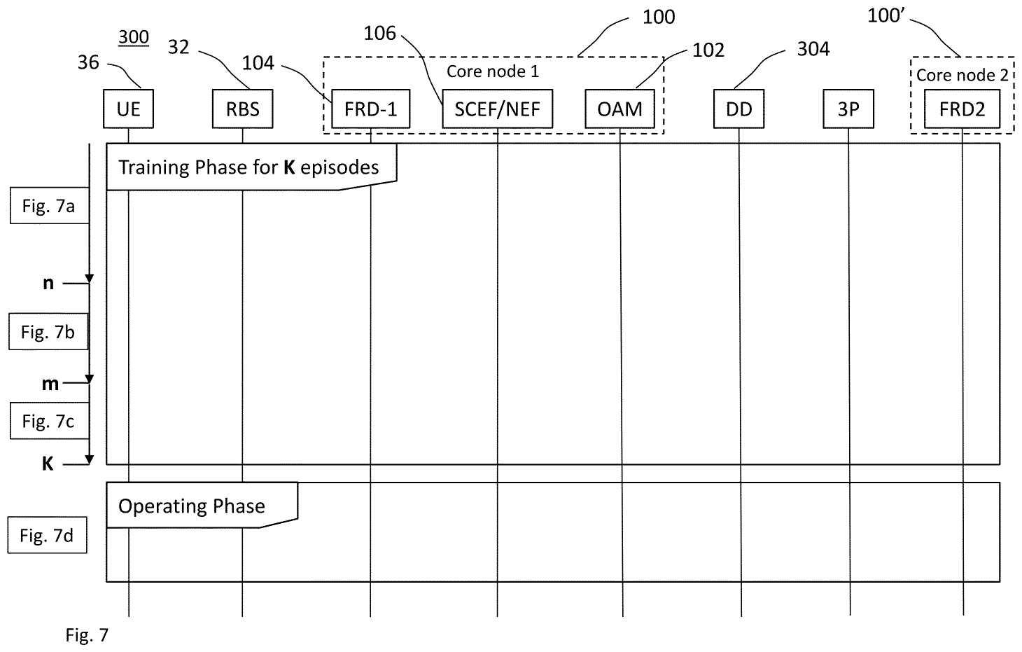

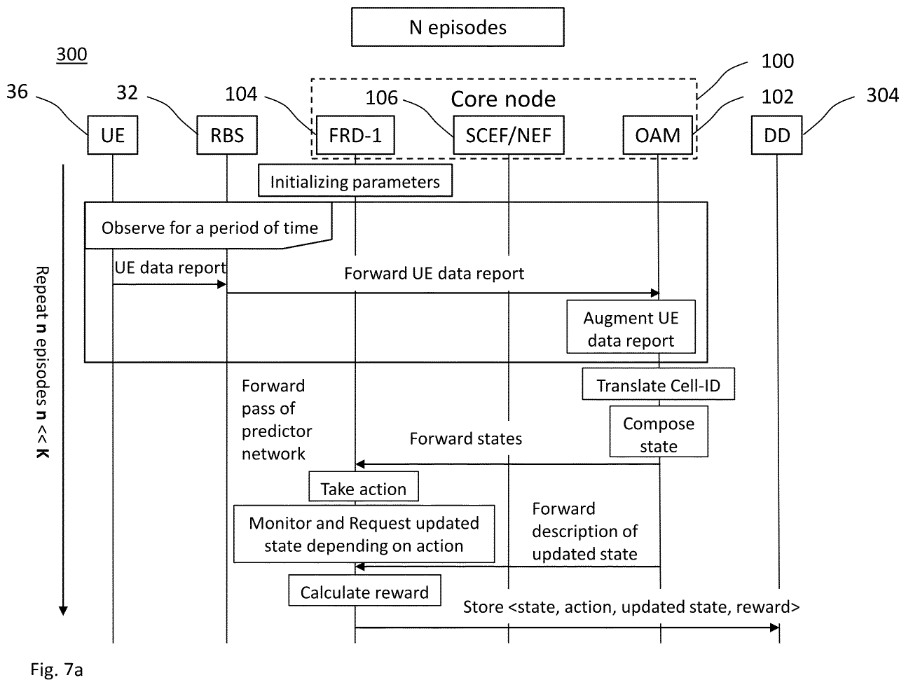

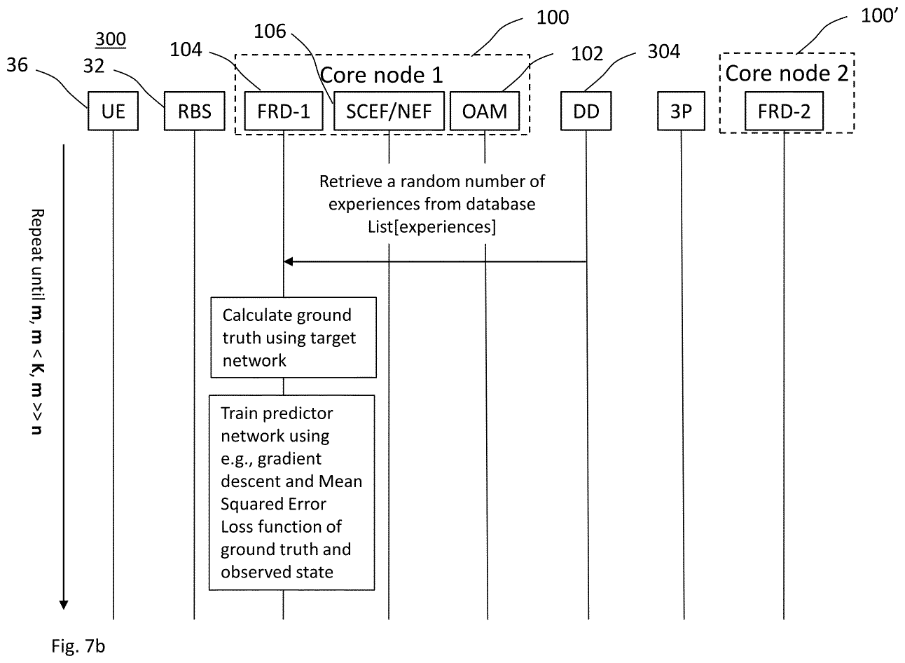

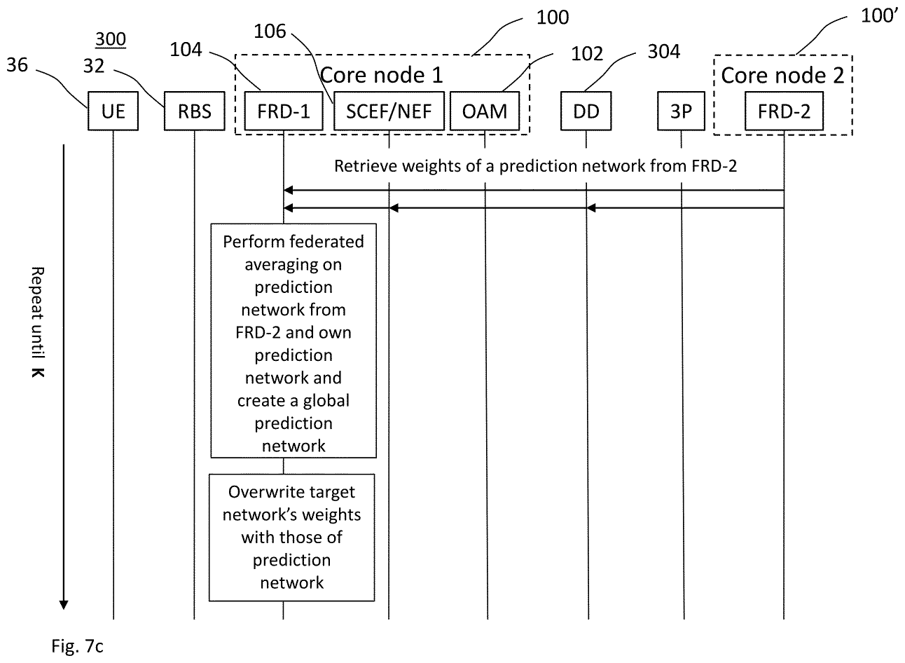

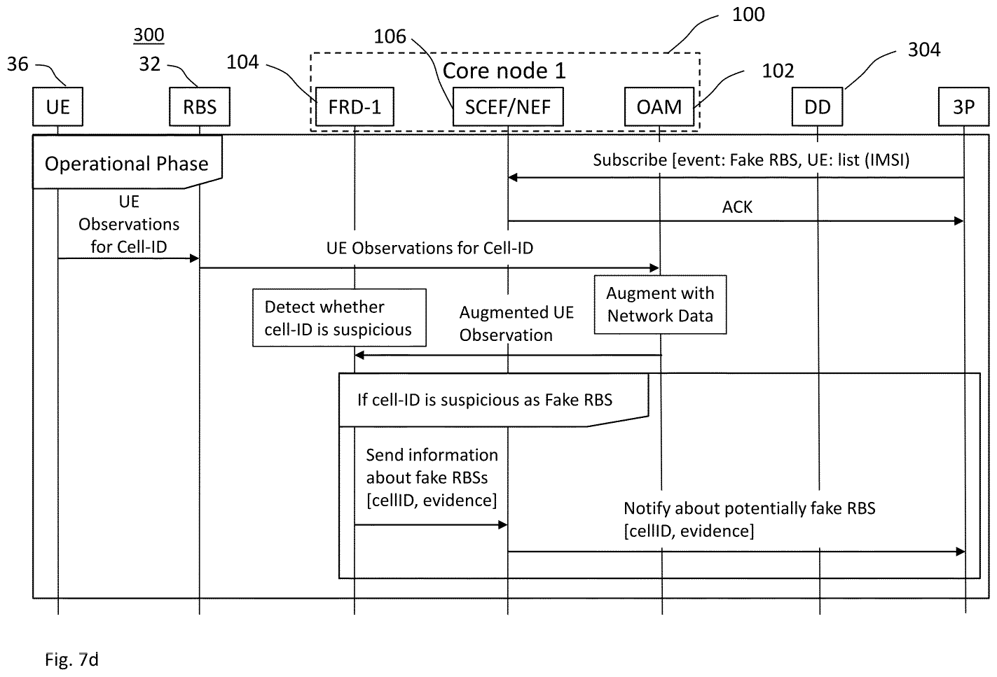

FIG. 7 schematically shows an example of sequence diagram for detecting a fake radio base station according to the method of FIG. 3, wherein the neural network uses double deep q-learning algorithm. The more details of the training phase loop and the operational phase is shown in FIG. 7a to FIG. 7d.

FIG. 7 illustrates an example process variant of Deep-Q learning called Double Deep Q-learning. According to this variant, the FRD module 104 (i.e., the agent) has 2 neural networks:
a Deep Q Network (DQN)—also referred to as a predictor network, and
a Target Q Network (TQN)—also referred to as a target network.

FIG. 7a schematically shows the first part of the training phase loop of the sequence diagram of FIG. 7. One way to make the training more stable, is using a technique called “target network”. The target network may be understood as a copy of NN to use for the state action function (e.g., Q (s′, a′) or predicted Q-value) value in maximizing the reward procedure (e.g., in the Bellman equation). The predicted Q-values of the target network, are used to back-propagate through and train the main NN (herein the “predictor network”). The target network's parameters may not be trained, but they may be periodically synchronized with the parameters of the main NN (e.g., predictor network). Using the target network's Q-values to train the main NN will improve the stability of the training step.

FIG. 7a, shows that the FRD module 104 (herein showed as FRD-1) of the core node 100 of operator 38 may optionally do initialization of parameters by initializing a target network and a predictor network. The training phase may begin by the NN randomizing weights for the DQN and weights for the TQN.

For a period of time (e.g., an hour, or a day, or a longer period of time) the RD 36 (e.g. UE) may send the observation (e.g., data report) comprising <cell-ID, RSRP, RSRQ> to the respective one RBS 32. Optionally the RD 36 may send additional measurements (e.g., RAT, timespan, etc.) as data report to the respective RBs 32. The RD 36 observation (e.g., data report) may be provided from the RD 36 using the radio resource control (RRC) measurement report functionality.

The RBS 32 may forward the RD 36 observations to the OAM module 102 of the core node 100. The OAM module 102 may augment the observation with the network information (e.g., other metrics, for example unexpected disappearance). The OAM module 102 may anonymize the received observations (e.g., translate cell-ID to latitude and longitude). The OAM module 102 may further combine the observations related to a respective RBS into a state (e.g., compose a state or compose a state description).

The OAM module 102 may send the states to the FRD module 104. The FRD module 104 may take an action (A) based on a selection policy (e.g., epsilon-greedy), calculate the reward (R) based on a likelihood (L) and action and store the 4-tuple <state, action, new state, reward> per each received states in local memory and/or a DD 304.

The FRD module 104 may subsequently “taking an action” (i.e., computing the prediction A using the DQN), gathering a 4-tuple experiences. The 4-tuple experience may preferably not be stored in a local buffer of the NN but in the DD 304.

FIG. 7a may iterate its loop for n episodes, n<<k, (herein k is the total number of training sample). FIG. 7a may be understood as a target network.

For example, in single-agent RL, an agent (e.g., The NN implemented at the FRD) may be informed by an environment (e.g., at least one of the RD 36 observation and/or states of the OAM module 102) about an update of the environment state (i.e., state description whether the respective RBS 32 is a fake RBS 34), and “takes an action” (i.e., predicts if the respective RBS 32 is a fake RBS 34) that yields (or more accurately awaits) an updated state and a reward (R) depending on the action (i.e., the predication) and the updated state (e.g., depending whether the prediction matches the updated state). Over time, the NN learns to “take the action” that yields the highest amount of reward. This learning in the sense of (e.g., deep) RL is performed using a NN which takes as input the experience and outputs the predicted value for all actions (e.g., a likelihood or probability for the respective RBS 32 being a fake RBS 34 or not). Thus, the NN indicates the action with the highest value of probability as the action of choice.

In any case, once the FRD module 104 receives the current state (e.g., state information) for the first time, the FRD “takes an action”, which means that the FRD may output a prediction (i.e., the “action”) if the respective RBS is fake. In the training phase, the “action” may not relate to any counter-measures. The “action” may relate to the RBS (e.g., as indicated by the cell-ID provided in the state description) and indicates a degree of trust that the RBS represented by the cell-ID is not fake. It may for example be a binary action space comprising [trusted, non-trusted], but can also have varying degrees of trust (e.g., a scale ranging from 1 to 5).

FIG. 7b schematically shows the second part of the training phase loop of the sequence diagram of FIG. 7. After n episodes, n<<k, The FRD module 104 may retrieve a random number of RD 36 observations (e.g., states) from the DD 304 (e.g., observations and/or states from the core node 100′ of one other operator 39).

The FRD module 104 may use the received states (e.g., RD observations) from the DD 304 and calculate ground truth using the target network. Herein the ground truth may be understood as the output of the target network. The FRD module 104 may further use the received states from the DD304 and train the prediction network, e.g., based on the gradient descent and mean squared error function of ground truth and observed value. FIG. 7b may iterate its loop until m episodes, m<k and m>>n.

At each iteration, the NN “takes an action” (i.e., computes the prediction A, e.g., using DQN) based on a selection policy. For example, if an epsilon-greedy selection policy is used, the NN ma take a random action early on (i.e., the NN may compute the prediction A as a random value without using DQN, e.g., for exploration), to be replaced with an informed action (i.e., the NN computes the prediction A using DQN, e.g., for exploitation), which may also be referred to as a forward-pass of DQN, later in the training phase.

Once the “action is taken” (i.e., the prediction A for the respective RBS 32 being a fake RBS 34 is computed), the FRD module 104 may wait to receive the updated state and the reward (e.g. corresponding to the prediction A and the updated state). The FRD module 104 may stores the 4-tuple of <state, action, reward, updated state> in the DD 304. After a set number of iterations has elapsed (e.g., 200), the FRD module may pull some 4-tuple data from the DD 304 and train may the NN (i.e., the DQN) using a mean squared error loss function of a ground truth minus a value of the “action being taken” (i.e., what is described by the reward). The ground truth may be provided by TQN.

FIG. 7c schematically shows the third part of the training phase loop of the sequence diagram of FIG. 7. The FRD module 104 may further retrieve the neural network weights of a trained NN from the FRD module of another core node 100′, optionally via the DD 304 and the NEF module 106.

The FRD module 104 may update the NN (e.g., the predictor network) based on an average of the neural network weights of the NN of the FRD module 104 of the core node 100. The FRD module 104 may overwrite the target network's weights with the updated weights of the predictor network.

During the training phase, the action (A) taken by the NN may not actuate any policy (e.g., a local policy how to deal with the detected fake RBS 34), but instead it may turn on a monitoring function at FRD module 104. That means the FRD module 104 waits until an updated state is provided by OAM, using both state and incorporated in the updated state and information gathered from OAM module 102 (e.g., network information). Then the FRD module may calculate a reward, which indicates how “effective the action” was, i.e., how accurate the prediction was. The reward may take the following information into account:
Measured RSRP and/or RSRQ values for the cell (e.g., obtained from the RD 36 observation reported to the RBS 32). These values may range from (−200, −80) for RSRP, and (−50, −10) for RSRQ (note that values lower than −200, −50 are rounded to −200, −50 during calculation of reward and values greater than −80 to −10, rounded to −80, −10). The RSRP value is measured in decibel-milliwatts (dBm) and RWRQ value in decibel (dB).
Protocol (e.g., RAT) that the RBS 32 uses, as a natural number (e.g., 2G is 2, 5G is 5, etc.);
Number of times that the RD 36 spent (e.g., camped) at the cell of the RBS 32. If this information is not available (because the RD does not report this information), then OAM may infer the number and time of the RD 36 disappearance from the mobile network. This is a set of CAMP={camp1, . . . , campX}, wherein for every campy belonging to CAMP there is a beginning and end expressed in some form of timestamp (e.g., YYYY-MM-DD hh:mm), campy=[begincampy, endcampy];
The time that the RD 36 detached from the network during the time of measurement, as in the CAMP above, TIME_DETACH={detach1, . . . detachk} wherein every record is marked by a beginning and an end.
The RD 36 data profile of current period in the uplink and downlink interface, versus historical data profile (e.g., assuming thrUEcurrentUL and thrUEcurrentDL to be the average throughput on the uplink (i.e., towards UE) and downlink interface of the UE for the measured period and thrUEhistUL and thrUEhistDL to be the historical throughput of the RD 36).

FIG. 7d schematically shows the operating phase loop of the sequence diagram of FIG. 7. The NEF module 106 may receive a message from a third party triggering the operational phase. The message may comprise an event (e.g., a fake RBS subscription, and/or an RD observation from the IMSI list). The NEF module 106 may send an acknowledge message back to the third party.

The training phase and the operating phase may be intertwined. The training phase should be of a sufficient duration, sufficient here denoting either a certain number of episodes/epochs that is preset or use of some type of metric (such as reward acquisition rate) to denote that the NN have been trained to a sufficient degree. The operating phase may follow a training phase and may be continuous or it may be triggered based on a special event. This event may for example be a public safety scenario where identification of fake RBSs has public safety/security implications. Such public safety scenarios may be spatial (e.g., concentrated at specific locations such as airports, hospitals, military installations, etc.), or temporal (e.g., in case of disasters such as floods or fires) or both.

The operator 38 may trigger the operating phase by subscribing to the NEF module 106 as shown in FIG. 7c for a list of RD 36, based on external information. In another embodiment the operating phase may be triggered automatically, e.g., by the mobility management entity (MME in 4G, AMF in 5G) detecting many requests for emergency attach within a preset time window, from a particular cell or a neighborhood of cells, which may in turn imply a critical situation.

The training phase may be triggered in conjunction with a fallback mechanism. In case during operating phase FRD modules 104 in the core nodes return many false positives (i.e., fake RBSs that are not fake), then the operating phase may stop, and training phase begin again, as described above.

The RD 36 may send the observation to the RBS 32. The RBS 32 may forward the observations to the OAM module 102. The OAM module 102 may augment the received observations with the network information. The OAM module 102 may send the augmented observations to the FRD module 104. The FRD module may operate the NN to detect a fake RBS 34.

Alternatively or in addition, the FRD module 104 may use the received states (e.g., experiences) from the FRD module of the one other core node 100′ as the ground truth (e.g., result of the target network) for the FRD module 104 of the core node 100.

Alternatively or in addition, the FRD module 104 may send a report indicative of a fake RBS presence to the NEF module 106. The NEF module 106 may send the report to the third party.

The same raining and operating phase may be performed for every operator's core node 100 and/or 100′ that participates in this federation. For example, the FRD module 104 of each RAN operator may store 4-tuple experiences in the DD 304. Alternatively or in addition, each FRD module may retrieve a plurality of 4-tuple observation from the DD 304 for the training of the NN (e.g., the DQN) of the respective FRD module.

An exemplary pseudo-code (or PlantUML code) for the method 200, e.g., according to the FIGS. 7a to 7d, may read:

@startuml
title Detection of Rogue RBS using Multi-Vendor Observations
participant UE
participant RBS
participant FRD
participant SEF
participant OAM
participant DD
participant 3P
note over UE, 3P: UE: User Equipment (Mobile devices)\nRBS:
Radio Base Station\nFRD: Fake RBS Detector (can be part of
NWDAF in 5G)\nSEF: Service Exposure Function(NEF in 5G, SCEF
in 4G)\nOAM: Operation, Administration and Maintenance (e.g.,
OSS)\nDD: Distributed Database (e.g., distributed
ledger)\n3P: Third-Party
loop Training Phase and Operational Phase Succeed each other
for the duration of the service
group Training Phase
loop For K Episodes
opt First time training
FRD−>FRD: Initialize target network, predictor network
end
group Observe for a period of time
UE−>RBS: UE Observation[cellID, RSRP, RSRQ]
opt Additional measurements from UE-side
note over UE, RBS: See TR 37.827
UE−>RBS: Send additional measurements\nlist[servingCellID,
RAT, timespan]
end
RBS−>OAM: Forward UE Observation\nlist[cellID, RSRP,
RSRQ]\nOPT[list[servingCellID,RAT,timespan]]
OAM−>OAM: Augment UE Observation with\nother metrics\n[e.g.,
unexpected dissapearance]
end
OAM−>OAM: Translate cellID to latitude,\nlongitude and
anonymize
OAM−>OAM: Compose state description\n[IMSI, cellID, RSRP,
RSRQ, RAT, timespan, ...]
OAM−>FRD: Forward State Description
FRD−>FRD: Take action based on selection policy (e.g., e-
greedy)\n[suspicious RBS||normal RBS, cellID]
note over FRD, OAM: OAM sends FRD a new state description as
per above
OAM−>FRD: New state description
FRD−>FRD: Calculate Reward based on new state Description
FRD−>DD: Store <state, action, new state, reward>
group After L episodes L << K
FRD<−DD: Retrieve a random number of UE Observations\nlist[UE
Observation]
FRD−>FRD: Calculate ground truth using target network
FRD−>FRD: Train prediction network using e.g., gradient
descent and \nMean Squared Error loss function of ground
\ntruth and observed value
end
group After M episodes M < K, M >> L
FRD−>FRD: Overwrite target network's\nweights with those of
prediction network
end
end
group Operational Phase
3P−>SEF: Subscribe [event:Fake RBS, UE:list(IMSI)]
SEF−>3P: ACK
UE−>RBS: UE Observation for cellID
RBS−>OAM: UE Observation
OAM−>OAM: Augment with network data
OAM−>FRD: Augmented UE Observation
FRD−>FRD: Detect whether cellID is suspicious
alt Suspicious cellID
FRD−>SEF: Send information about fake RBSs\n[cellID,
evidence]
SEF−>3P: Notify about potential\nfake RBS [cellID, evidence]
end
end
end
@enduml

The shared training data between core nodes of operators may improve the training of the neural network and/or decreasing the training time. The shared training data between core nodes of operators may increase the accuracy of the detecting a fake RBS.

Optionally, once the prediction network (e.g., DQN) for the one or more other operators (e.g., core node 100′ of the operator 39) has completed its training, a copy of the neural network weights of the prediction network (e.g., DQN), i.e. neural parameters, may be send from FRD module of core node 100′ to FRD module of core node 100 (optionally, and vice versa) and the two algorithms (i.e., the weights) are averaged (e.g., the weights of corresponding nodes in the prediction networks are averaged). This enables the learnings of the two different predictor networks (e.g., DQNs) to be combined without revealing sensitive information from operator 39.

Afterwards, in order to keep the training stable, weights of the TQN (also referred to as TQN weights) are copied to DQN after a large number of iterations have elapsed. In another embodiment which can be combined with other embodiments, instead of having operator 38 averaging the neural parameters of every operator a trusted node that can communicate with both operator 38 and operator 39 can assume that role instead, receiving neural parameters of the prediction network form each operator and producing the averaged prediction network which combines information from all operators.

The proposed solution method 200 of FIG. 3 and device aspects of FIG. 1 and FIG. 2, there is no need for knowing the ground truth for training the NN. The method 200 is further adaptive to new types of threats and may benefit from the RD 36 reports from more than one operator (e.g., in a geographical area).

Moreover, the RD 36 may not require any change in the behavior and the method is compliant with any RD 36 (e.g., UE) in 3GPP. In addition the method 200 does not require any necessary preparation and/or downtime.

The reason for having a distributed ledger is due to its immutability and replicability properties. The former property does not allow deletion of any data, thus providing transparency (and therefore building trust) among all operators participating in the disclosed system. The latter property enables every operator to have the exact, synchronized copy of the same data. Other entities (e.g., law enforcement) can participate in the same database and have “read access” to it, so they can detect and suppress the fake RBSs reported by the operators.

Since latitude and longitude is independent of the cell-ID of the network, the other network operators may benefit this information.

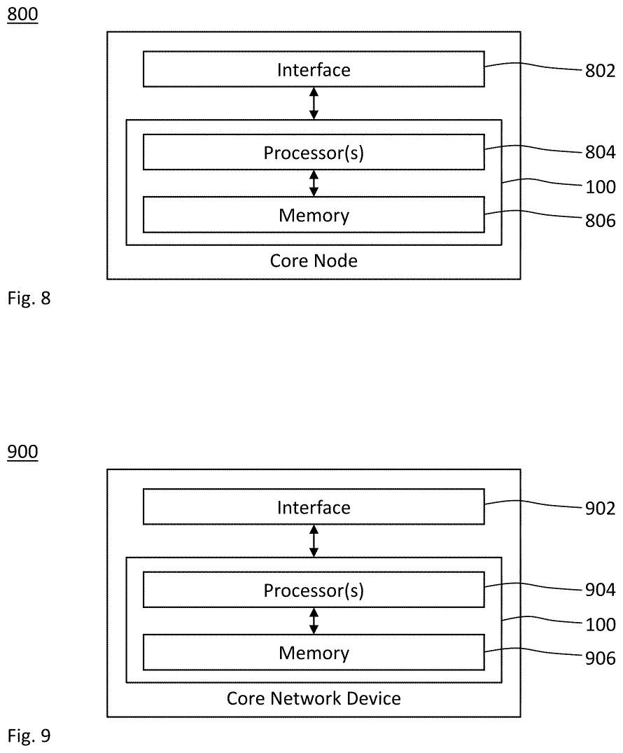

FIG. 8 shows a schematic block diagram for an embodiment of the device 100. The device 100 comprises processing circuitry, e.g., one or more processors 804 for performing the method 200 and memory 806 coupled to the processors 804. For example, the memory 806 may be encoded with instructions that implement at least one of the modules 102, 104 and 106 and/or perform at least one of the steps 202 to 212.

The one or more processors 804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, core node functionality. For example, the one or more processors 804 may execute instructions stored in the memory 806. Such functionality may include providing various features and steps discussed herein, including any of the benefits disclosed herein. The expression “the device being operative to perform an action” may denote the device 100 being configured to perform the action.

As schematically illustrated in FIG. 8, the device 100 may be embodied by a core node 800. The core node 800 comprises an interface 802 coupled to the device 100 for (e.g., radio) communication with one or more network nodes 32 and/or radio devices 36, e.g., functioning as a reporting UE 36.

FIG. 9 shows a schematic block diagram for an embodiment of the device 100. The device 100 comprises processing circuitry, e.g., one or more processors 904 for performing the method 200 and memory 906 coupled to the processors 904. For example, the memory 906 may be encoded with instructions that implement at least one of the modules 102, 104 and 106.

The one or more processors 904 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, core network functionality. For example, the one or more processors 904 may execute instructions stored in the memory 906. Such functionality may include providing various features and steps discussed herein, including any of the benefits disclosed herein. The expression “the device being operative to perform an action” may denote the device 100 being configured to perform the action.

As schematically illustrated in FIG. 9, the device 100 may be embodied by a core network 900. The core network 900 comprises an interface 902 coupled to the device 100 for (e.g., radio) communication with one or more network nodes 32, e.g., functioning as RBS 32 or a reporting UEs 36.

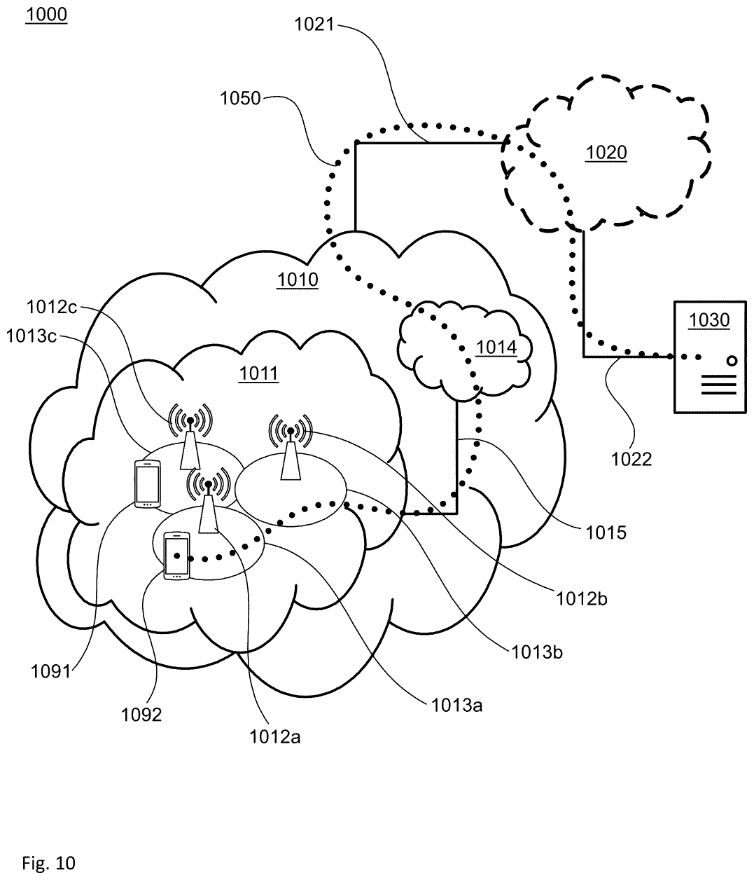

With reference to FIG. 10, in accordance with an embodiment, a communication system 1000 includes a telecommunication network 1010, such as a 3GPP-type cellular network, which comprises an access network 1011, such as a radio access network, and a core network 1014. The access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to the core network 1014 over a wired or wireless connection 1015. A first user equipment (UE) 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

Any of the base stations 1012 may embody the RBS 32, and/or any of the UEs 1091, 1092 may embody the RDs 36.

The telecommunication network 1010 is itself connected to a host computer 1030, which may be embodied in the hardware and/or software of a standalone server, a cloud-implemented server, a distributed server or as processing resources in a server farm. The host computer 1030 may be under the ownership or control of a service provider, or may be operated by the service provider or on behalf of the service provider. The connections 1021, 1022 between the telecommunication network 1010 and the host computer 1030 may extend directly from the core network 1014 to the host computer 1030 or may go via an optional intermediate network 1020. The intermediate network 1020 may be one of, or a combination of more than one of, a public, private or hosted network; the intermediate network 1020, if any, may be a backbone network or the Internet; in particular, the intermediate network 1020 may comprise two or more sub-networks (not shown).

The communication system 1000 of FIG. 10 as a whole enables connectivity between one of the connected UEs 1091, 1092 and the host computer 1030. The connectivity may be described as an over-the-top (OTT) connection 1050. The host computer 1030 and the connected UEs 1091, 1092 are configured to communicate data and/or signaling via the OTT connection 1050, using the access network 1011, the core network 1014, any intermediate network 1020 and possible further infrastructure (not shown) as intermediaries. The OTT connection 1050 may be transparent in the sense that the participating communication devices through which the OTT connection 1050 passes are unaware of routing of uplink and downlink communications. For example, a base station 1012 need not be informed about the past routing of an incoming downlink communication with data originating from a host computer 1030 to be forwarded (e.g., handed over) to a connected UE 1091. Similarly, the base station 1012 need not be aware of the future routing of an outgoing uplink communication originating from the UE 1091 towards the host computer 1030.

By virtue of the method 200 being performed by any one of the core nodes 800 and/or any one of the core networks 900, the performance or range of the OTT connection 1050 can be improved, e.g., in terms of increased throughput and/or reduced latency and/or increasing security. More specifically, the host computer 1030 may indicate to the RAN in the system 300 or any one of the RBSs 32 and/or any one of the RDs 36 (e.g., on an application layer) the presence of a fake RBS 34.

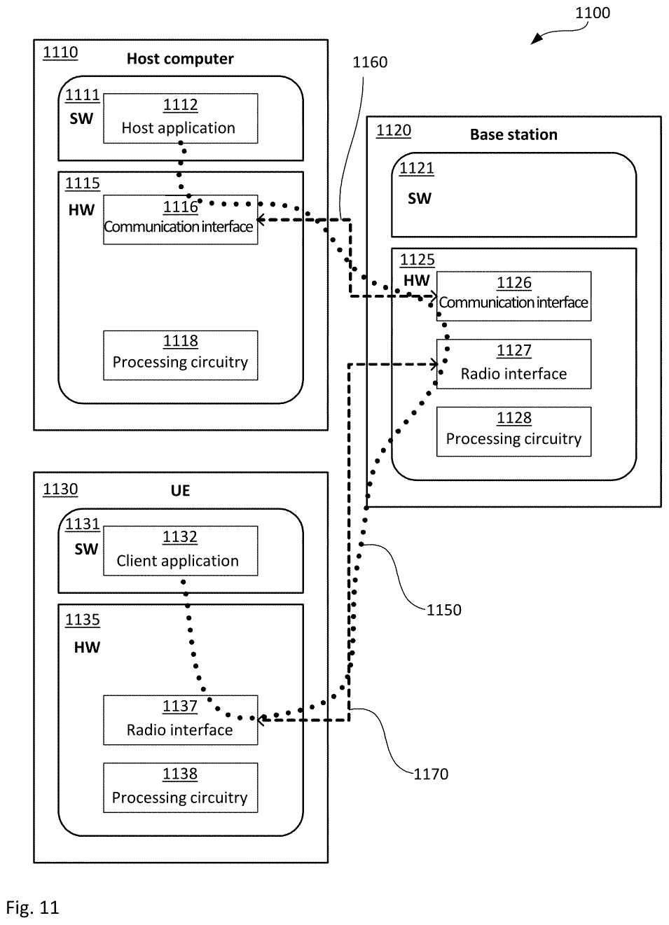

Example implementations, in accordance with an embodiment of the UE, base station and host computer discussed in the preceding paragraphs, will now be described with reference to FIG. 11. In a communication system 1100, a host computer 1110 comprises hardware 1115 including a communication interface 1116 configured to set up and maintain a wired or wireless connection with an interface of a different communication device of the communication system 1100. The host computer 1110 further comprises processing circuitry 1118, which may have storage and/or processing capabilities. In particular, the processing circuitry 1118 may comprise one or more programmable processors, application-specific integrated circuits, field programmable gate arrays or combinations of these (not shown) adapted to execute instructions. The host computer 1110 further comprises software 1111, which is stored in or accessible by the host computer 1110 and executable by the processing circuitry 1118. The software 1111 includes a host application 1112. The host application 1112 may be operable to provide a service to a remote user, such as a UE 1130 connecting via an OTT connection 1150 terminating at the UE 1130 and the host computer 1110. In providing the service to the remote user, the host application 1112 may provide user data, which is transmitted using the OTT connection 1150. The user data may depend on the location of the UE 1130. The user data may comprise auxiliary information or precision advertisements (also: ads) delivered to the UE 1130. The location may be reported by the UE 1130 to the host computer, e.g., using the OTT connection 1150, and/or by the base station 1120, e.g., using a connection 1160.

The communication system 1100 further includes a base station 1120 provided in a telecommunication system and comprising hardware 1125 enabling it to communicate with the host computer 1110 and with the UE 1130. The hardware 1125 may include a communication interface 1126 for setting up and maintaining a wired or wireless connection with an interface of a different communication device of the communication system 1100, as well as a radio interface 1127 for setting up and maintaining at least a wireless connection 1170 with a UE 1130 located in a coverage area (not shown in FIG. 11) served by the base station 1120.

The communication interface 1126 may be configured to facilitate a connection 1160 to the host computer 1110. The connection 1160 may be direct, or it may pass through a core network (not shown in FIG. 11) of the telecommunication system and/or through one or more intermediate networks outside the telecommunication system. In the embodiment shown, the hardware 1125 of the base station 1120 further includes processing circuitry 1128, which may comprise one or more programmable processors, application-specific integrated circuits, field programmable gate arrays or combinations of these (not shown) adapted to execute instructions. The base station 1120 further has software 1121 stored internally or accessible via an external connection.

The communication system 1100 further includes the UE 1130 already referred to. Its hardware 1135 may include a radio interface 1137 configured to set up and maintain a wireless connection 1170 with a base station serving a coverage area in which the UE 1130 is currently located. The hardware 1135 of the UE 1130 further includes processing circuitry 1138, which may comprise one or more programmable processors, application-specific integrated circuits, field programmable gate arrays or combinations of these (not shown) adapted to execute instructions. The UE 1130 further comprises software 1131, which is stored in or accessible by the UE 1130 and executable by the processing circuitry 1138. The software 1131 includes a client application 1132. The client application 1132 may be operable to provide a service to a human or non-human user via the UE 1130, with the support of the host computer 1110. In the host computer 1110, an executing host application 1112 may communicate with the executing client application 1132 via the OTT connection 1150 terminating at the UE 1130 and the host computer 1110. In providing the service to the user, the client application 1132 may receive request data from the host application 1112 and provide user data in response to the request data. The OTT connection 1150 may transfer both the request data and the user data. The client application 1132 may interact with the user to generate the user data that it provides.

It is noted that the host computer 1110, base station 1120 and UE 1130 illustrated in FIG. 11 may be identical to the host computer 1030, one of the base stations 1012a, 1012b, 1012c and one of the UEs 1091, 1092 of FIG. 10, respectively. This is to say, the inner workings of these entities may be as shown in FIG. 11, and, independently, the surrounding network topology may be that of FIG. 10.

In FIG. 11, the OTT connection 1150 has been drawn abstractly to illustrate the communication between the host computer 1110 and the UE 1130 via the base station 1120, without explicit reference to any intermediary devices and the precise routing of messages via these devices. Network infrastructure may determine the routing, which it may be configured to hide from the UE 1130 or from the service provider operating the host computer 1110, or both. While the OTT connection 1150 is active, the network infrastructure may further take decisions by which it dynamically changes the routing (e.g., on the basis of load balancing consideration or reconfiguration of the network).

The wireless connection 1170 between the UE 1130 and the base station 1120 is in accordance with the teachings of the embodiments described throughout this disclosure. One or more of the various embodiments improve the performance of OTT services provided to the UE 1130 using the OTT connection 1150, in which the wireless connection 1170 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1150 between the host computer 1110 and UE 1130, in response to variations in the measurement results. The measurement procedure and/or the network functionality for reconfiguring the OTT connection 1150 may be implemented in the software 1111 of the host computer 1110 or in the software 1131 of the UE 1130, or both. In embodiments, sensors (not shown) may be deployed in or in association with communication devices through which the OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of the OTT connection 1150 may include message format, retransmission settings, preferred routing etc.; the reconfiguring need not affect the base station 1120, and it may be unknown or imperceptible to the base station 1120. Such procedures and functionalities may be known and practiced in the art. In certain embodiments, measurements may involve proprietary UE signaling facilitating the host computer's 1110 measurements of throughput, propagation times, latency and the like. The measurements may be implemented in that the software 1111, 1131 causes messages to be transmitted, in particular empty or “dummy” messages, using the OTT connection 1150 while it monitors propagation times, errors etc.

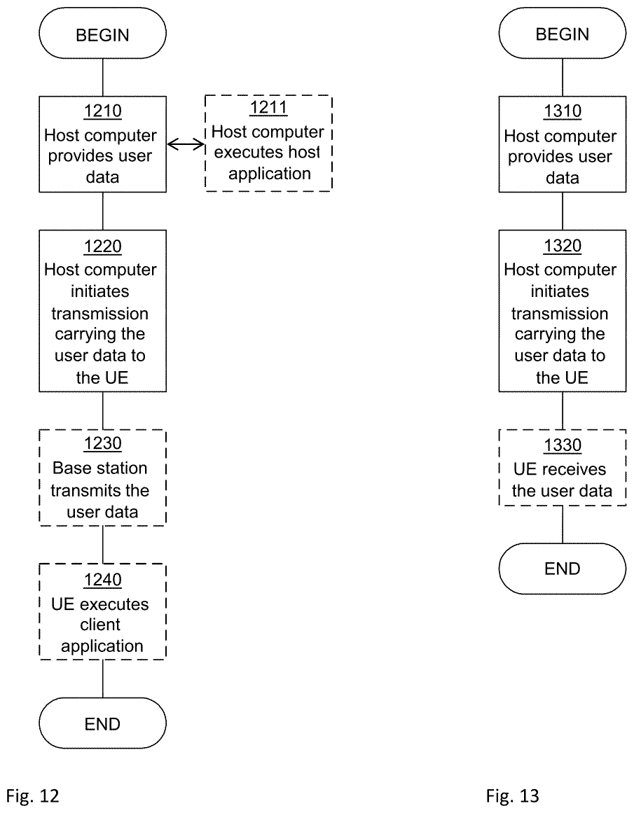

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this paragraph. In a first step 1210 of the method, the host computer provides user data. In an optional substep 1211 of the first step 1210, the host computer provides the user data by executing a host application. In a second step 1220, the host computer initiates a transmission carrying the user data to the UE. In an optional third step 1230, the base station transmits to the UE the user data which was carried in the transmission that the host computer initiated, in accordance with the teachings of the embodiments described throughout this disclosure. In an optional fourth step 1240, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this paragraph. In a first step 1310 of the method, the host computer provides user data. In an optional substep (not shown) the host computer provides the user data by executing a host application. In a second step 1320, the host computer initiates a transmission carrying the user data to the UE. The transmission may pass via the base station, in accordance with the teachings of the embodiments described throughout this disclosure. In an optional third step 1330, the UE receives the user data carried in the transmission.

As has become apparent from above description, at least some embodiments of the technique allow for an improved detection of a fake RBS. Same or further embodiments can ensure that the traffic transmitted by the radio device to the RBS, or vice versa, is taken care with a high degree of security.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method performed by a core node of an operator comprising a fake radio base station detector, FRD module, for detecting a fake radio base station, RBS, in a radio access network, RAN, comprising a plurality of RBSs, the method comprising or initiating steps of:
training a neural network in the FRD module according to reinforcement learning with a set of experiences, each of the experiences relating to one of the RBSs and comprises:
a state based on at least one observation of at least one radio device relative to the respective one of the RBSs;
an action indicative of a degree of trust whether the respective one of the RBSs is a fake RBS;
an updated state for the respective one of the RBSs; and
a reward based on a likelihood function;
the reward being indicative of a correlation between the action and the likelihood function for the respective one of the RBSs being a fake RBS based on the respective one of the states;
the likelihood function being determined by the core node based on the at least one observation of the at least one radio device relative to the respective one of the RBSs; and
operating the neural network for detecting a fake RBS.

2. The method of claim 1, wherein the at least one observation of the at least one radio device comprises at least one of:
a channel quality of a radio channel between the at least one radio device and the respective one of the RBSs;
a signal to noise ratio, SINR, measured at the at least one radio device;
a received signal strength indicator, RSSI, measured at the at least one radio device;
reference signal received power, RSRP, measured at the at least one radio device;
reference signal received quality, RSRQ, measured at the at least one radio device;
at least one international mobile subscriber identity, IMSI, of the at least one radio device;
a cell-ID of a cell of the respective one of the RBSs;
a latitude of the respective of one of the at least one radio device or a latitude of a cell of the respective one of the RBSs;
a longitude of the respective of one of the at least one radio device or a longitude of a cell of the respective one of the RBSs;
a radio access technology, RAT, of the respective one of the RBSs or a generation of the RAT of the respective one of the RBSs;
a timespan spent by the at least one radio device camped on a cell of the respective one of the RBSs;
a timespan spent by the at least one radio device detached from a cell of the respective one RBSs;
a data rate profile of the at least one radio device in a cell of the respective one RBSs; and
a change of a data rate profile of the at least one radio device in a cell of the respective one RBSs.

3. The method of claim 1, wherein the training of the neural network further comprising or initiating the step of:
receiving at least one measurement report indicative of the at least one observation of the at least one radio device.

4. The method of claim 2, further comprising or initiating at least one of the steps of:
anonymizing the states of the experiences by replacing observations that are indicative of an operator of the RAN or of the at least one radio device by a geographical information indicative of a location of the respective one of the RBSs or the at least one radio device;
translating the cell-ID of the received at least one observation to a latitude and a longitude of the respective one of the RBSs; and
translating the at least one IMSI of the received at least one observation to a latitude and a longitude of the at least one radio device.

5. The method of claim 3, further comprising or initiating:
augmenting the received at least one observation with network information of the RAN, the network information comprising at least one of:
a latitude of the respective of one of the at least one radio device or a latitude of a cell of the respective one of the RBSs;
a longitude of the respective of one of the at least one radio device or a longitude of a cell of the respective one of the RBSs;
a RAT of the respective one of the RBSs or a generation of the RAT of the respective one of the RBSs;
a timespan spent by the at least one radio device camped on a cell of the respective one of the RBSs;
a timespan spent by the at least one radio device detached from a cell of the respective one RBSs;
a data rate profile of the at least one radio device in a cell of the respective one RBSs; and
a change of a data rate profile of the at least one radio device in a cell of the respective one RBSs.

6. The method of claim 1, wherein the state relative to the respective one of the RBSs is based on multiple observations of multiple radio devices, the method further comprising or initiating the step of:
combining the multiple observations relative to the respective one of the RBSs into the state relative to the respective one of the RBSs.

7. The method of claim 1, the method further comprising or initiating the step of:
storing, in a distributed database, DD, the states relating to the plurality of RBSs or the states relating to all of the RBSs of the operator.

8. The method of claim 1, wherein the training comprises:
sending, to the FRD module, the states relating to the plurality of RBSs or the states relating to all of the RBSs of the operator.

9.-11. (canceled)

12. The method of claim 7, further comprising or initiating the step of:
storing the set of experiences each comprising the state, the action, the reward, and the updated state, relative to the respective one RBS in the DD, wherein the DD is shared with a core node of at least one other operator of the RAN, via a network exposure function, NEF module.

13. The method of claim 7, wherein the training of the neural network further comprising or initiating the step of:
retrieving a plurality of experiences of a core node of at least one other operator from the DD for the training or a retraining, one or both of via the NEF module and to the FRD module of the core node.

14. (canceled)

15. (canceled)

16. The method of claim 7, further comprising or initiating the step of:
receiving neural network weights of a trained neural network of the FRD module of the core node of at least one other operator from the DD.

17. The method of claim 16, further comprising or initiating step of:
updating the neural network based on an average of the neural network weights of the neural network of FRD module of the core node of the operator and the received neural network weights of the neural network of FRD module of a core node of the at least one other operator from the DD.

18. The method of claim 1, wherein the training of the neural network of the FRD module uses at least one of:
an associative reinforcement learning;
a deep reinforcement learning;
q-learning;
deep q-learning;
a deep q-learning reinforcement learning algorithm;
double deep q-learning or a double deep q-learning reinforcement learning algorithm, wherein the neural network comprises a training prediction network and a target network, wherein the target network provides a ground truth for the training of the training prediction network based on those experiences related to the operator, and wherein the target network is updated based on a combination of the neural network weights of the training prediction network and the neural network weights received from the at least one other operator;
an actor critic reinforcement learning algorithm;
a federated learning, FL;
a safe reinforcement learning, and
a partially supervised reinforcement learning.

19. The method of claim 1, wherein the operating of the neural network for detecting a fake RBS results in a report that is indicative of a presence of at least one fake RBS in the RAN.

20. The method of claim 19, wherein the report is sent to a third party, wherein the third party is at least one of:
a radio device served by the RAN;
a distributed database, DD, wherein at least a core node of another operator has at least read access to the report; and
an enterprise customer.

21. (canceled)

22. (canceled)

23. A core node of an operator, the core node comprising a fake radio base station detector, FRD, module for detecting a fake radio base station, RBS, in a radio access network, RAN, comprising a plurality of RBSs, the core node comprising memory operable to store instructions and processing circuitry operable to execute the instructions, such that the core node is operable to:
train a neural network in the FRD module according to reinforcement learning with a set of experiences, each of the experiences relating to one of the RBSs and comprising:
a state based on at least one observation of at least one radio device relative to the respective one of the RBSs;
an action indicative of a degree of trust whether the respective one of the RBSs is a fake RBS;
an updated state for the respective one of the RBSs; and
a reward based on a likelihood function;
the reward being indicative of a correlation between the action and the likelihood function, for the respective one of the RBSs being a fake RBS based on the respective one of the states;
the likelihood function being determined by the core node based on the at least one observation of the at least one radio device relative to the respective one of the RBSs; and
operate the neural network for detecting a fake RBS.

24. The core node of claim 23, further comprising a network exposure function, NEF, module and an operation administration and management, OAM, module.

25. The core node of claim 23, wherein the at least one observation of the at least one radio device comprises at least one of:
a channel quality of a radio channel between the at least one radio device and the respective one of the RBSs;
a signal to noise ratio, SINR, measured at the at least one radio device;
a received signal strength indicator, RSSI, measured at the at least one radio device;
reference signal received power, RSRP, measured at the at least one radio device;
reference signal received quality, RSRQ, measured at the at least one radio device;
at least one international mobile subscriber identity, IMSI, of the at least one radio device;
a cell-ID of a cell of the respective one of the RBSs;
a latitude of the respective of one of the at least one radio device or a latitude of a cell of the respective one of the RBSs;
a longitude of the respective of one of the at least one radio device or a longitude of a cell of the respective one of the RBSs;
a radio access technology, RAT, of the respective one of the RBSs or a generation of the RAT of the respective one of the RBSs;
a timespan spent by the at least one radio device camped on a cell of the respective one of the RBSs;
a timespan spent by the at least one radio device detached from a cell of the respective one RBSs;
a data rate profile of the at least one radio device in a cell of the respective one RBSs; and
a change of a data rate profile of the at least one radio device in a cell of the respective one RBSs.

26.-28. (canceled)

29. A communication system, comprising:
a radio access network, RAN, comprising a plurality of RBSs;
at least one core node of at least one operator, each of the at least one core node comprising a fake radio base station detector, FRD, module for detecting a fake RBS in the RAN, each of the at least one code node comprising memory operable to store instructions and processing circuitry operable to execute the instructions, such that the core node is operable to:
train a neural network in the FRD module according to reinforcement learning with a set of experiences, each of the experiences relating to one of the RBSs and comprising:
a state based on at least one observation of at least one radio device relative to the respective one of the RBSs;
an action indicative of a degree of trust whether the respective one of the RBSs is a fake RBS;
an updated state for the respective one of the RBSs; and
a reward based on a likelihood function;
the reward being indicative of a correlation between the action and the likelihood function, for the respective one of the RBSs being a fake RBS based on the respective one of the states;
the likelihood function being determined by the core node based on the at least one observation of the at least one radio device relative to the respective one of the RBSs; and
operate the neural network for detecting a fake RBS; and
a distributed database, DD, in data communication with the least one core node.

30. (canceled)

31. The communication system according to claim 29, further comprising an interface to a third party, wherein one or both:
the interface is configured to send, as the result of the operating, a report from the core node indicative of the presence of a fake RBS in the RAN; and
the third party is at least one of:
a radio device served by the RAN;
an operation and maintenance, OAM, node of at least one other operator, having at least read access to the report in the DD; and
an enterprise customer.
